(19) United States
(12) Patent Application Publication
(10) Pub. No.: US 2008/0269052 A1
(43) Pub. Date: Oct. 30, 2008

(54) USE of PYRIDINE-2-OXY-3-CARBOXAMIDES AS SAFENERS

(76) Inventors: Christopher Rosinger, Hofheim (DE); Frank Ziemer, Kriftel (DE); Thomas Auler, Leichlingen (DE); Udo Bickers, Wietmarschen (DE); Erwin Hacker, Hochheim (DE)

Correspondence Address: William F. Lawrence, Esq.;c/o FROMMER, LAWRENCE & HAUG LLP, 745 Fifth Avenue, New York, NY, 10151, US

(21) Appl. No.: 12/111,448

(22) Filed: Apr. 29, 2008

(30) Foreign Application Priority Data
Apr. 30, 2007 (EP) 07400012.6

(51) Int. Cl. A01N 25/32

(52) U.S. Cl. 504/100; 504/105

(57) ABSTRACT

According to the invention, compounds of the general formula (I) or salts thereof (pyridine-2-oxy-3-carboxamides),

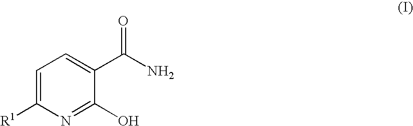

in which R¹ is a (C₁-C₄)-haloalkyl radical can be employed as safeners, i.e. as agents for preventing or reducing phytotoxic effects of pesticides, preferably herbicides, on useful plants.

### INCORPORATION BY REFERENCE

This application claims benefit under 35 U.S.C. 119(a) of European patent application 07400012.6, filed on 30 Apr. 2007.

Any foregoing applications, including European patent application EP 07400012.6, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

### DESCRIPTION

The present invention relates to useful-plant-protecting compositions comprising specific compounds as safeners for reducing phytotoxic actions of pesticides, in particular of herbicides, as safeners.

When controlling unwanted organisms in crops of plants which are useful for agriculture or forestry by using pesticides, the useful plants are frequently also damaged to a greater or lesser extent by the pesticides employed. This unwanted phytotoxic effect is encountered in particular with the use of a considerable number of herbicides in crops of useful plants such as, for example, corn, rice or cereals—and there primarily in the post-emergence application. In some instances, the useful plants can be protected against the phytotoxic properties of the pesticides by employing safeners or antidotes, without diminishing or substantially impairing the pesticidal activity against the harmful organisms. In some cases, even an improved pesticidal action against harmful organisms such as weeds was observed.

The compounds hitherto known as safeners belong to a large number of different chemical structure classes, their suitablity as saferners generally also depending on the chemical structures of the pesticides and on the crops of useful plants.

Known for a long time have been the safener actions of compounds from the group of the phenoxy- or heteroaryloxyalkanecarboxylic acids, provided these compounds are applied in combination with herbicides. Examples of such compounds are MCPA and similar compounds which are at the same time herbicidally active against harmful plants, or cloquintocet-mexyl.

Known are furthermore safeners from the group of the derivatives of N-phenyl-substituted heteroaromatic carboxylic esters having a plurality of heteroatoms in the heterocycle. Examples of such safeners are the safeners mefenpyr-diethyl and isoxadifen-ethyl, which are used in commercial products.

WO-A-2004/084631 (US 2004-0224844) discloses the use of hydroxyl-substituted aromatic carboxylic acid derivatives. WO 2005/015994 (US 2005-037922) describes specific derivatives of salicylic acid as safeners. These compounds are suitable in particular for use as safeners in crops of corn and soybeans.

Furthermore, WO 2005/112630 (US 2005-256000) discloses 1,2-dihydrochinoxalin-2-one derivatives as safeners.

Active compounds from the chemical class of the pyridones with pesticidal properties are known from the literature. Various biological actions are described; thus, for example, WO 2001/014339 (US 2002-177578) describes the fungicidal action of certain substituted pyridonecarboxamides, WO-A-2005/042492 (US 2007-196406) and WO-A-2005/042493 (US 2007-037858) describe inter alia the fungicidal action of heterocyclylcarboxanilides. EP 544151 (U.S. Pat. No. 5,344,813) describes the action of hydroxyl-substituted pyridonecarboxamides as herbicides.

Also known are representatives having pharmacological properties. Thus, WO 2001/055115 (U.S. Pat. No. 6,794,397) describes nicotinanilides as inductors of apoptosis, and US 2004/0116479 describes dialkylnicotinamides as inhibitors of angiogenesis.

Furthermore, EP 522392 (U.S. Pat. No. 5,235,060) describes 6-trifluoromethyl-substituted pyridonecarboxamides as precursors for the synthesis of herbicidally active sulfonylureas. Helv. Chim. Acta 71 (1988) 596-601 and GB 2305174 mention 1,2-dihydro-2-oxo-6-trifluoromethylpyridine-3-carboxamide, 6-chloro(difluoro)methyl-1,2-dihydro-2-oxopyridine-3-carboxamide and 6-difluoromethyl-1,2-dihydro-2-oxopyridine-3-carboxamide as intermediates in the synthesis of pyranopyridines.

The use of such compounds as safeners in combination with certain pesticides has hitherto not been disclosed.

WO 2006/007981 (US 2007-265164) describes a method for identifying compounds which induce the defense of plants against pathogens, where an increase of the expression of plant-endogenous genes is considered to be an indication for the induction.

Here, 1,2-dihydro-2-oxo-6-trifluoromethylpyridine-3-carboxamide is mentioned as part of a group of six compounds which may be referred to as safeners. A safener action confirmed by biological tests on plants has hitherto not been disclosed for this compound, and is not sufficiently disclosed by WO 2006/007981 either.

In particular the expression values obtained according to WO 2006/007981 for the compound, which in some cases are at a considerably lower level than those for commercially available safeners also mentioned, lead it to be expected in the best case that, as safeners, they are considerably less suitable, if at all.

When safeners were used to protect useful plants against damage by pesticides, it was found that the known safeners may in many cases have disadvantages. These include:
the safener reduces the efficacy of the pesticides, in particular that of herbicides, against the harmful plants,
the useful-plant-protecting properties are insufficient,
in combination with a certain herbicide, the spectrum of the useful plants in which the safener/herbicide is to be employed is not sufficiently wide,
a certain safener can only be combined with a small number of herbicides,
by using safeners, the application rate to be applied and the amount of formulation is increased, which may cause problems during the application.

For the reasons mentioned, there is a need to provide alternative useful-plant-protecting compositions comprising compounds having safener action and, if appropriate, pesticides, preferably herbicides.

The invention provides the use of compounds of the formula (I) or salts thereof (pyridine-2-oxy-3-carboxamides),

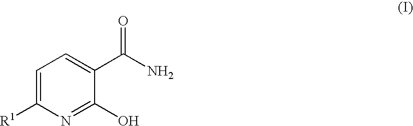

in which
R¹ is a (C₁-C₄)-haloalkyl radical, preferably a radical of the formula CF₃, CF₂Cl or CF₂H,
   as safeners, i.e. agents for preventing or reducing phytotoxic actions of pesticides, preferably herbicides, on useful plants, preferably crop plants.

If, by hydrogen shifts, the compounds are capable of forming tautomers whose structure would not be covered by the formula (I), these tautomers are nevertheless embraced by the definition of the compounds of the formula (I) according to the invention. The definition of the compounds of the formula (I) embraces in particular the tautomeric structures of the formula (I′) (pyrid-2-one-3-carboxamides) or salts thereof

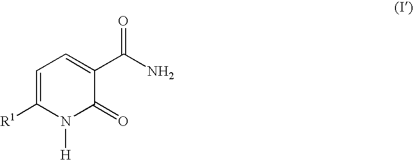

in which
R¹ is as defined for formula (I).

Depending on the nature and the attachment of the substituents, the compounds of the formula (I) may be present as stereoisomers. All possible stereoisomers defined by their specific spatial form, such as enantiomers, diastereomers, Z- and E-isomers and their mixtures, are embraced by the formula (I).

The compounds of the formula (I) are capable of forming salts. Salts may be formed by a base acting on compounds of the formula (I) carrying an acidic hydrogen atom, for example the hydrogen atom in the hydroxyl group at the pyridyl ring. Suitable bases are, for example, organic amines, and also ammonium, alkali metal or alkaline earth metal hydroxides, carbonates and bicarbonates, in particular sodium hydroxide, carbonat and bicarbonate and potassium hydroxide, carbonate and bicarbonate. These salts are compounds in which the acidic hydrogen is replaced by an agriculturally suitable cation, for example metal salts, in particular alkali metal salts or alkaline earth metal salts, in particular sodium salts and potassium salts, or else ammonium salts, salts with organic amines or quaternary ammonium salts.

By a suitable inorganic or organic acid, such as, for example, a mineral acid such as, for example, HCl, HBr, H₂SO₄ or HNO₃, or an organic acid, such as formic acid, acetic acid, propionic acid, oxalic acid or sulfonic acids, forming an adduct with a basic group such as, for example, amino, alkylamino, dialkylamino, the compounds of the formula (I) are capable of forming salts. These salts then contain the conjugated base of the acid as anion.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

The invention also provides useful-plant-protecting compositions comprising compounds of the formula (I) or their salts in combination with pesticides, in particular herbicides, and, if appropriate, formulation auxiliaries.

The compounds of the formula (I) are known or can be prepared analogously to known processes. Their application as safeners for the reduction of phytotoxic actions of pesticides on useful plants has hitherto not been known.

Thus, some compounds of the formula (I) have already been specifically described as intermediates for preparing active compounds, see GB-A-2305174 (comp. (I) in which R¹=CF₃, CF₂Cl or CF₂H and R³=R⁴=H).

For example, some compounds of the formula (I) have been described in principle as intermediates for preparing herbicidally active sulfonylureas or pyranopyridines, and they can be prepared by the known processes. EP 522392, Helv. Chim. Acta 71 (1988) 596-601 and GB-A-2305174, for example, describe processes for preparing such compounds. GB-A-2305174 describes the preparation of 6-trifluoromethyl-2-hydroxynicotinamide by reacting malonamide and (E)-1,1,1-trifluoro-3-buten-2-one.

Hereinbelow, the compounds of the formula (I) and their salts are, in short, also referred to as “compounds (I)” used according to the invention.

The terms used above and further below are familiar to the person skilled in the art and have in particular the meanings illustrated below:

The term “(C₁-C₄)-alkyl” is a short notation for open-chain alkyl having 1 to 4 carbon atoms corresponding to the stated range of carbon atoms, i.e. it includes the radicals methyl, ethyl, 1-propyl, 2-propyl, 1-butyl, 2-butyl, 2-methylpropyl and tert-butyl. Correspondingly, general alkyl radicals having a wider stated range of carbon atoms, for example “(C₁-C₆)-alkyl”, also include straight-chain or branched alkyl radicals having a larger number of carbon atoms, i.e. in the example also the alkyl radicals having 5 and 6 carbon atoms.

Alkyl radicals, including in the composite meanings, such as haloalkyl, are, for example, methyl, ethyl, n- or isopropyl, n-, iso, t- or 2-butyl, pentyls, hexyls, such as n-hexyl, isohexyl and 1,3-dimethylbutyl, heptyls, such as n-heptyl, 1-methylhexyl and 1,4-dimethylpentyl.

The term “halogen” denotes, for example, fluorine, chlorine, bromine or iodine. Haloalkyl or (C₁-C₄)haloalkyl is alkyl or (C₁-C₄)alkyl respectively, which are partially or fully substituted by identical or different halogen atoms, preferably from the group consisting of fluorine, chlorine and bromine, in particular from the group consisting of fluorine and chlorine, for example monohaloalkyl, such as CH₂CH₂Cl, CH₂CH₂F, CH₂ClCH₃, CH₂FCH₃, CH₂Cl, CH₂F; perhaloalkyl such as CCl₃ or CF₃ or CF₃CF₂; polyhaloalkyl, such as CHF₂, CH₂F, CH₂FCHCl, CHCl₂, CF₂CF₂H, CH₂CF₃, CH₂ClCH₃, CH₂FCH₃.

If a skeleton is substituted “by one or more radicals” from a list of radicals (=group) or a generically defined group of radicals, this includes in each case the simultaneous substitution by a plurality of identical and/or structurally different radicals.

When a general radical is defined as “hydrogen”, this means a hydrogen atom.

The “yl position” of a radical refers to its point of attachment.

Mainly for reasons of increased crop-plant- or useful-plant-protecting action (safener action), better selectivity and/or better preparability, those uses according to the invention of compounds of the formula (I) mentioned or salts thereof are of particular interest where individual radicals have one of the preferred meanings already mentioned or mentioned below, or in particular those where one or more of the preferred meanings already mentioned or mentioned below are combined.

Preference is given to the compounds of the formula (I) mentioned or salts (and tautomers) thereof in which R¹ is a (C₁-C₂)-alkyl radical which is substituted by one or more halogens from the group consisting of fluorine and chlorine. More preferably, R¹ is a methyl radical which is substituted by one or more halogens from the group consisting of fluorine and chlorine.

More preference is given to the compounds of the formulae (Ia), (Ib) and (Ic) and their salts (and tautomers):

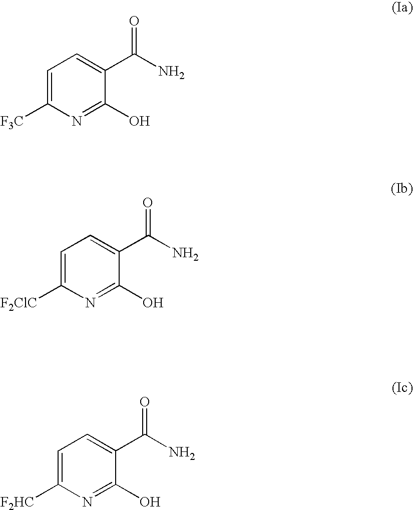

The compounds of the general formula (I) can be prepared, for example, by
(a) reacting a carboxylic acid of the general formula (II)

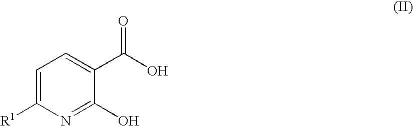

in which R¹ is as defined for the compound of the formula (I) to be prepared, with ammonia or an ammonium salt,
if appropriate in the presence of a carboxylic acid-activating reagent, for example N,N-carbonyldiimidazole (CDI), or a dehydrating agent, for example dicyclohexylcarbodiimide (DCC), to give the compound of the formula (I) or
(b) reacting a carboxylic ester of the general formula (III)

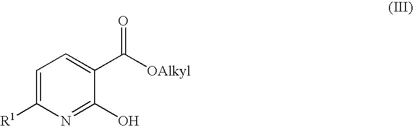

in which R¹ is as defined for the compound of the formula (I) to be prepared and “Alkyl” is an alkyl radical, for example methyl or ethyl, with ammonia or an ammonium salt to give the compound of the formula (I) or
(c) reacting a carbonyl halide or a carboxylic anhydride of the general formula (IV),

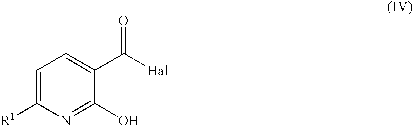

in which R¹ is as defined for the compound of the formula (I) to be prepared and Hal is a halogen atom, for example chlorine, or an acyloxy radical, with ammonia or an ammonium salt to give the compound of the formula (I),
(d) reacting a compound of the formula (V),

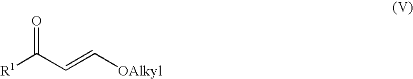

in which R¹ is as defined for the compound of the formula (I) to be prepared, and “Alkyl” is an alkyl radical, for example methyl or ethyl,
with malonamide to give the compound of the formula (I).

The amide formations according to variant (a) can be carried out, for example, in an inert organic solvent in a temperature range between 0° C. and 150° C., preferably between 0° C. and 50° C. Suitable organic solvents are, for example, polar protic or aprotic solvents, such as ethers, for example diethyl ether, tetrahydrofuran and dioxane, or nitriles, such as acetonitrile, or amides, such as dimethylformamide.

The amide formations according to variant (b) can be carried out, for example, in an inert organic solvent in a temperature range between 0° C. and 150° C., preferably between 50° C. and 100° C. Suitable organic solvents are, for example, polar protic or aprotic solvents, such as ethers, for example tetrahydrofuran and dioxane, or nitriles, such as acetonitrile, or amides, such as dimethylformamide. However, preference is given to the amide formation according to variant (b) at elevated temperatures by reacting the undiluted reactants.

The amide formations according to variant (c) can be carried out, for example, in the presence of an acid binder in an inert organic solvent in a temperature range between 0° C. and 150° C., preferably between 0° C. and 50° C. Suitable organic solvents are, for example, polar protic or aprotic solvents, such as ethers, for example diethyl ether, tetrahydrofuran and dioxane, or nitriles, such as acetonitrile, or amides, such as dimethylformamide. Acid binders are, for example, alkali metal or alkaline earth metal carbonates, such as, for example, sodium carbonate, potassium carbonate or calcium carbonate, alkali metal or alkaline earth metal hydroxides, such as sodium hydroxide, potassium hydroxide or calcium hydroxide, or alkali metal hydrides or amides, such as sodium hydride or potassium hydride or sodium amide or potassium amide, or else organic bases, such as triethylamine, pyridine, dimethylaminopyridine, DBU (1,8-diazabicyclo[5.4.0]-undec-7-ene), DBN (1,5-diazabicyclo[4.3.0]non-5-ene) and 1,4-diaza-bicyclo[2.2.2]octane.

The amide formations according to variant (d) can be carried out analogously to the processes described in EP 522392 and Helv. Chim. Acta 71 (1988) 596-601 and GB 2305174. In general, the malonamide can be converted in an organic anhydrous polar protic or aprotic solvent, for example in an alcohol, with a strong base, such as an alkali metal, alkali metal hydride or alkali metal alkoxide, into a reactive salt, and then be reacted with the compound of the formula (V). The reaction with the compound (V) can generally be carried out in a temperature range between 0° C. and the boiling point of the solvent (depending on the solvent up to about 150° C.).

The compounds of the general formulae (II), (III) and (IV) are either commercially available or can be prepared analogously to methods known to the person skilled in the art (for example Helv. Chim. Acta 71 (1988) 596; EP 502740 (U.S. Pat. No. 5,393,734); EP 522392).

Thus, for example, compounds of the formula (III) can be obtained by reacting alkoxyvinyl ethers of the formula (V) with alkyl malonamides of the formula (VI).

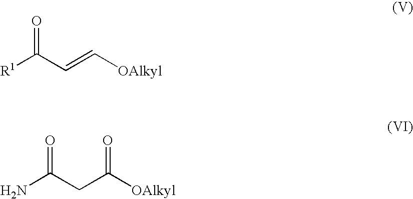

The starting materials of the formula (V) are either commercially available or can be prepared by known methods (for example Synthesis 2000, 738-742; J. Fluor. Chem., 107, 2001, 285-300; Organometallics 15, 1996, 5374-5379).

The invention also provides a method for protecting crop plants or useful plants against phytotoxic actions of pesticides, in particular herbicides which cause damage to plants, which method comprises using compounds of the formula (I) or salts thereof as safeners, preferably by applying an effective amount of the compounds of the formula (I) or their salts to the plants, to parts of plants or their seeds (or seed).

The safeners (=compounds of the formula (I) or salts thereof), together with active compounds (pesticides, preferably herbicides), are suitable for the selective control of harmful organisms in a number of plant crops, for example in crops of economic importance, such as cereals (wheat, barley, triticale, rye, rice, corn, millet), sugar beet, sugar cane, oilseed rape, cotton, sunflower, peas, beans and soybeans. Of particular interest is the use in monocotyledonous crops, such as cereals (wheat, barley, rye, triticale, sorghum), including corn and rice, and monocotyledonous vegetable crops, but also in dicotyledonous crops, such as, for example, soybean, oilseed rape, cotton, grape vines, vegetable plants, fruit plants and ornamental plants. Herbicide/safener combinations are preferred for the selective control of harmful plants in useful plants (crops). The herbicide/safener combinations with the safeners (I) are also suitable for controlling harmful plants in beds and plots of useful plants and ornamental plants, such as, for example, lawn plots with useful or ornamental lawn, especially lolium, meadow grass or Bermuda grass.

Also of interest from among the useful plants or crop plants in which the pesticide/safener combinations preferably herbicide/safener combinations with safeners (I) may be used are mutant crops which are completely or partially tolerant to certain pesticides or completely or partially tolerant transgenic crops, for example corn crops which are resistant to glufosinate or glyphosate, or soybean crops which are resistant to herbicidal imidazolinones. However, the particular advantage of the safeners used in this novel way is their efficient action in crops which normally are insufficiently tolerant to the pesticides being applied.

For the joint use with pesticides, the compounds of the formula (I) according to the invention can be applied simultaneously with the active compounds or in any order, and they are then capable of reducing or completely eliminating harmful side effects of these active compounds in crop plants, without negatively affecting or substantially reducing the activity of these active compounds against unwanted harmful organisms. Here, even damage caused by using a plurality of pesticides, for example a plurality of herbicides or herbicides in combination with insecticides or fungicides, can be reduced substantially or eliminated completely. In this manner, it is possible to extend the field of use of conventional pesticides considerably.

If the pesticides are herbicides, these compositions are, after appropriate dilution, applied either directly to the area under cultivation, to the already germinated harmful and/or useful plants or to the already emerged harmful and/or useful plants. If the compositions according to the invention do not comprise any pesticide, these compositions can be employed by the tankmix method—i.e. the user mixes and dilutes the separately available products (=the pesticide and the agent protecting the useful plants) immediately prior to application to the area to be treated—or prior to the application of a pesticide, or after the application of a pesticide, or for the pretreatment of seed, i.e., for example, for dressing the seed of the useful plants. Preferably, safener and pesticide are applied within a short time of one another, in particular when the safener is applied to the plants after the pesticide, eg. herbicide.

Accordingly, the invention also provides a method for the selective control of harmful plants in crops of useful plants which comprises applying an effective useful-plant-protecting amount of one or more compounds (I) or salts thereof before, after or simultaneously with an amount, effective against harmful plants, of one or more herbicides to the plants, parts of plants, plant seeds or seed.

The advantageous actions of the compounds (I) according to the invention are observed when they are used together with the pesticides by the pre-emergence method or the post-emergence method, for example in the case of simultaneous application as a tank mix or a coformulation or in the case of a separate application, in parallel or in succession (split application). It is also possible to repeat the application a number of times. In some cases, it may be expedient to combine a pre-emergence application with a post-emergence application. In most cases, one option is a post-emergence application to the useful plant or crop plant together with a simultaneous or later application of the pesticide. Also possible is the use of the compounds (I) according to the invention for seed dressing, for (dip) treatment of seedlings (for example rice) or for the treatment of other propagation material (for example potato tubers).

When using the compounds (I) according to the invention in combination with herbicides, in addition to the safener action, enhanced action in the herbicidal action, against harmful plants is frequently also observed. Furthermore, in many cases, there is an improved growth of the useful plants and crop plants, and it is possible to increase the harvest yields.

The compositions according to the invention may comprise one or more pesticides. Suitable pesticides are, for example, herbicides, insecticides, fungicides, acaricides and nematicides, which, when used on their own, would cause phytotoxic damage to the crop plants or would probably cause damage. Of particular interest are corresponding pesticidally active compounds from the groups of the herbicides, insecticides, acaricides, nematicides and fungicides, in particular herbicides.

The weight ratio of safener to pesticide can be varied within wide limits and is generally in the range from 1:100 to 100:1, preferably from 1:20 to 20:1, in particular from 1:10 to 10:1. The optimum weight ratio of safener to pesticide generally depends both on the respective safener used and the respective pesticide, and on the type of useful plant or crop plant to be protected. The required application rate of safener can, depending on the pesticide used and the type of useful plant to be protected, be varied within wide limits and is generally in the range from 0.001 to 10 kg, preferably from 0.01 to 1 kg, in particular from 0.05 to 0.5 kg, of safener per hectare. The weight ratios and amounts required for a successful treatment can be determined by simple preliminary experiments.

For seed dressing, for example, from 0.005 to 20 g of safener per kilogram of seed, preferably from 0.01 to 10 g of safener per kilogram of seed, in particular from 0.05 to 5 g of safener per kilogram of seed, are used.

If solutions of safener are used for seed treatment and the seeds or seedlings are wetted with the solutions, the suitable concentration is generally in the range from 1 to 10 000 ppm, preferably from 100 to 1000 ppm, based on the weight. The weight ratios and amounts required for a successful treatment can be determined by simple preliminary experiments.

The safeners can be formulated in the customary manner, separately or together with the pesticides. Accordingly, the present invention also provides the useful-plant-protecting or crop-plant-protecting compositions comprising the safeners and customary formulation auxiliaries or comprising the safeners and pesticides and optionally formulation auxiliaries.

Preferred is the joint application of safener and pesticide, in particular that of safener and herbicide as a readymix or the use by the tankmix method.

Preference is also given to using the safener (I) in the treatment of seed, followed by the application of pesticides, preferably herbicides, after sowing by the pre- or post-emergence method.

The compounds of the formula (I) or their salts, as such or in the form of their preparations (formulations), can be used in combination with other pesticidally active compounds, such as, for example, insecticides, acaricides, nematicides, herbicides, fungicides, safeners, fertilizers and/or growth regulators, for example als finished formulation or as tank mixes. Here, the combination formulations can be prepared based on the formulations mentioned above, taking into account the physical properties and stabilities of the active compounds to be combined.

Suitable as combination partners for the active compounds according to the invention in formulations of mixtures or in tank-mixes are, for example, known, preferably herbicidally active compounds whose action is based on the inhibition of, for example, acetolactate synthase, acetyl-coenzyme-A carboxylase, PS I, PS II, HPPDO, phytoene desaturase, protoporphyrinogen oxidase, glutamine synthetase, cellulose biosynthesis, 5-enolpyruvylshikimate 3-phosphate synthetase. Such compounds and also other compounds which can be used, in some cases having an unknown or a different mechanism of action, are described, for example, in Weed Research 26, 441-445 (1986), or in “The Pesticide Manual”, 12th edition 2000, or 13th edition 2003 or 14th edition 2006/2007, or in the corresponding “e-Pesticide Manual”, version 4 (2006), all published by the British Crop Protection Council, (hereinbelow also referred to in short as “PM”), and in the literature cited therein. Lists of “common names” are also available in “The Compendium of Pesticide Common Names” on the Internet. Examples of herbicides known from the literature and also safeners, which may be combined with the compounds of the formula (I) are, for example, the active compounds from Table 1 below (note: the compounds are referred to either by the “common name” according to the International Organization for Standardization (ISO) or by the chemical name, if appropriate together with a customary code number):

### Table 1: Active Compounds as Co-Components for Safeners (I)

acetochlor; acibenzolar-5-methyl; acifluorfen(-sodium); aclonifen; AD-67; AKH 7088, i.e. [[[1-[5-[2-chloro-4-(trifluoromethyl)phenoxy]-2-nitrophenyl]-2-methoxyethylidene]-amino]oxy]acetic acid and methyl [[[1-[5-[2-chloro-4-(trifluoromethyl)phenoxy]-2-nitrophenyl]-2-methoxyethylidene]amino]oxy]acetate; alachlor; alloxydim(-sodium); ametryn; amicarbazone, amidochlor, amidosulfuron; aminopyralid; amitrol; AMS, i.e. ammonium sulfamate; ancimidol; anilofos; asulam; atrazine; aviglycine; azafenidin, azimsulfuron (DPX-A8947); aziprotryn; barban; BAS 516H, i.e. 5-fluoro-2-phenyl-4H-3,1-benzoxazin-4-one; beflubutamid (UBH-509), benazolin(-ethyl); bencarbazone; benfluralin; benfuresate; benoxacor; bensulfuron(-methyl); bensulide; bentazone; benzfendizone; benzobicyclon, benzofenap; benzofluor; benzoylprop(-ethyl); benzthiazuron; bialaphos; bifenox; bispyribac(-sodium) (KIH-2023); borax; bromacil; bromobutide; bromofenoxim; bromoxynil; bromuron; buminafos; busoxinone; butachlor; butafenacil, butamifos; butenachlor (KH-218); buthidazole; butralin; butroxydim, butylate; cafenstrole (CH-900); carbetamide; carfentrazone(-ethyl); CDAA, i.e. 2-chloro-N,N-di-2-propenylacetamide; CDEC, i.e. 2-chlorallyl diethyldithiocarbamate; chlomethoxyfen; chloramben; chlorazifop-butyl, chlorbromuron; chlorbufam; chlorfenac; chlorfenprop; chlorflurecol(-methyl); chlorflurenol(-methyl); chloridazon; chlorimuron(-ethyl); chlormequat(chloride); chlornitrofen; chlorophthalim (MK-616); chlorotoluron; chloroxuron; chlorpropham; chlorsulfuron; chlorthal-dimethyl; chlorthiamid; chlortoluron, cinidon(-methyl and -ethyl), cinmethylin; cinosulfuron; clefoxydim, clethodim; clodinafop and its ester derivatives (for example clodinafop-propargyl); clofencet; clomazone; clomeprop; cloprop; cloproxydim; clopyralid; clopyrasulfuron(-methyl), cloquintocet(-mexyl); cloransulam(-methyl), cumyluron (JC 940); cyanamide; cyanazine; cycloate; cyclosulfamuron (AC 104); cycloxydim; cycluron; cyhalofop and its ester derivatives (for example the butyl ester, DEH-112); cyperquat; cyprazine; cyprazole; cyprosulfamide; daimuron; 2,4-D, 2,4-DB; dalapon; daminozide; dazomet; n-decanol; desmedipham; desmetryn; di-allate; dicamba; dichlobenil; dichlormid; dichlorprop(-P) salts; diclofop and its esters, such as diclofop-methyl; diclofop-P(-methyl); diclosulam, diethatyl(-ethyl); difenoxuron; difenzoquat(metilsulfate); diflufenican; diflufenzopyr(-sodium); dimefuron; dimepiperate, dimethachlor; dimethametryn; dimethazone; dimethenamid (SAN-582H); dimethenamide-P; dimethylarsinic acid; dimethipin; dimetrasulfuron, dinitramine; dinoseb; dinoterb; diphenamid; dipropetryn; diquat salts; dithiopyr; diuron; DNOC; eglinazine-ethyl; EL 77, i.e. 5-cyano-1-(1,1-dimethylethyl)-N-methyl-1H-pyrazole-4-carboxamide; endothal; epoprodan, EPTC; esprocarb; ethalfluralin; ethametsulfuron-methyl; ethephon; ethidimuron; ethiozin; ethofumesate; ethoxyfen and its esters (for example the ethyl ester, HN-252); ethoxysulfuron, etobenzanid (HW 52); F5231, i.e. N-[2-chloro-4-fluoro-5-[4-(3-fluoropropyl)-4,5-dihydro-5-oxo-1H-tetrazol-1-yl]phenyl]-ethanesulfonamide; fenchlorazole(-ethyl); fenclorim; fenoprop; fenoxan, fenoxaprop and fenoxaprop-P and also their esters, for example fenoxaprop-P-ethyl and fenoxaprop-ethyl; fenoxydim; fentrazamide, fenuron; ferrous sulfate; flamprop(-methyl or -isopropyl or -isopropyl-L); flamprop-M(-methyl or -isopropyl); flazasulfuron; florasulam, fluazifop and fluazifop-P and their esters, for example fluazifop-butyl and fluazifop-P-butyl; fluazolate, flucarbazone(-sodium), flucetosulfuron; fluchloralin; flufenacet; flufenpyr(-ethyl); flumetralin; flumetsulam; flumeturon; flumiclorac(-pentyl), flumioxazin (S-482); flumipropyn; fluometuron, fluorochloridone, fluorodifen; fluoroglycofen(-ethyl); flupoxam (KNW-739); flupropacil (UBIC-4243); flupropanoate; flupyrsulfuron(-methyl)(-sodium); flurazole; flurenol(-butyl); fluridone; fluorochloridone; fluoroxypyr(-meptyl); flurprimidol, flurtamone; fluthiacet(-methyl) (KIH-9201); fluthiamide, fluxofenim; fomesafen; foramsulfuron, forchlorfenuron; fosamine; furilazole; furyloxyfen; gibberillic acid; glufosinate(-ammonium); glyphosate(-isopropylammonium); halosafen; halosulfuron(-methyl); haloxyfop and its esters; haloxyfop-P (=R-haloxyfop) and its esters; HC-252; hexazinone; imazamethabenz(-methyl); imazamethapyr, imazamox, imazapic, imazapyr; imazaquin and salts, such as the ammonium salt; imazethamethapyr; imazethapyr; imazosulfuron; inabenfide; indanofan; indole-3-acetic acid; 4-indol-3-ylbutyric acid; iodosulfuron-methyl(-sodium); ioxynil; isocarbamid; isopropalin; isoproturon; isouron; isoxaben; isoxachlortole, isoxadifen(-ethyl); isoxaflutole, isoxapyrifop; karbutilate; lactofen; lenacil; linuron; maleic hydrazide (MH), MCPA; MCPB; mecoprop(-P); mefenacet; mefenpyr(-diethyl); mefluidid; mepiquat(-chloride); mesosulfuron(-methyl); mesotrione, metam; metamifop; metamitron; metazachlor; methabenzthiazuron; metham; methazole; methoxyphenone; methylarsonic acid; methylcyclopropene; methyldymron; methyl isothiocyanate; methabenzthiazuron; metobenzuron; metobromuron; (alpha-)metolachlor; metosulam (XRD 511); metoxuron; metribuzin; metsulfuron-methyl; molinate; monalide; monocarbamide dihydrogensulfate; monolinuron; monuron; MT 128, i.e. 6-chloro-N-(3-chloro-2-propenyl)-5-methyl-N-phenyl-3-pyridazinamine; MT 5950, i.e. N-[3-chloro-4-(1-methylethyl)phenyl]-2-methylpentanamide; naproanilide; napropamide; naptalam; NC 310, i.e. 4-(2,4-dichlorobenzoyl)-1-methyl-5-benzyloxypyrazole; neburon; nicosulfuron; nipyraclofen; nitralin; nitrofen; nitrophenolate mixture; nitrofluorfen; nonanoic acid; norflurazon; orbencarb; orthasulfamuron; oxabetrinil; oryzalin; oxadiargyl (RP-020630); oxadiazon; oxasulfuron, oxaziclomefone, oxyfluorfen; paclobutrazol; paraquat(dichloride); pebulate; pelargonic acid, pendimethalin; penoxsulam; pentachlorophenol; pentanochlor; pentoxazone, perfluidone; pethoxamid; phenisopham; phenmedipham; picloram; picolinafen, pinoxaden, piperophos; piributicarb; pirifenopbutyl; pretilachlor; primisulfuron(-methyl); probenazole; procarbazone-(sodium), procyazine; prodiamine; profluralin; profoxydim; prohexadione(-calcium); prohydrojasmon; proglinazine(-ethyl); prometon; prometryn; propachlor; propanil; propaquizafop; propazine; propham; propisochlor; propoxycarbazone(-sodium) (MKH-6561); n-propyl dihydrojasmonate; propyzamide; prosulfalin; prosulfocarb; prosulfuron (CGA-152005); prynachlor; pyraclonil; pyraflufen(-ethyl) (ET-751); pyrasulfotole; pyrazolynate; pyrazon; pyrazosulfuron(-ethyl); pyrazoxyfen; pyribenzoxim, pyributicarb, pyridafol, pyridate; pyriftalid; pyriminobac(-methyl) (KIH-6127); pyrimisulfan (KIH-5996); pyrithiobac(-sodium) (KIH-2031); pyroxasulfone (KIH-485); pyroxofop and its esters (for example the propargyl ester); pyroxsulam; quinclorac; quinmerac; quinoclamine, quinofop and its ester derivatives, quizalofop and quizalofop-P and their ester derivatives, for example quizalofop-ethyl; quizalofop-P-tefuryl and -ethyl; renriduron; rimsulfuron (DPX-E 9636); S 275, i.e. 2-[4-chloro-2-fluoro-5-(2-propynyloxy)phenyl]-4,5,6,7-tetrahydro-2H-indazole;
saflufenacil, secbumeton; sethoxydim; siduron; simazine; simetryn; sintofen; SN 106279, i.e. 2-[[7-[2-chloro-4-(trifluoromethyl)phenoxy]-2-naphthalenyl]oxy]propanoic acid and methyl 2-[[7-[2-chloro-4-(trifluoromethyl)phenoxy]-2-naphthalenyl]oxy]propanoate; sulcotrione, sulfentrazone (FMC-97285, F-6285); sulfazuron; sulfometuron(-methyl); sulfosate (ICI-A0224); sulfosulfuron, TCA; tebutam (GCP-5544); tebuthiuron; tecnacene; tembotrione; tefuryltrione; tepraloxydim, terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiafluamide, thiazafluoron; thiazopyr (Mon-13200); thidiazimin (SN-24085); thidiazuron; thiencarbazone; thifensulfuron(-methyl); thiobencarb; Ti 35; tiocarbazil; topramezone; tralkoxydim; tri-allate; triasulfuron; triaziflam, triazofenamide; tribenuron(-methyl); triclopyr; tridiphane; trietazine; trifloxysulfuron; trifluralin; triflusulfuron and esters (for example the methyl ester, DPX-66037); trimeturon; trinexapac; tritosulfuron, tsitodef; uniconazole; vernolate; WL 110547, i.e. 5-phenoxy-1-[3-(trifluoromethyl)phenyl]-1H-tetrazole; D-489; LS 82-556; KPP-300; NC-324; NC-330; DPX-N8189; SC-0774; DOWCO-535; DK-8910; V-53482; PP-600 and MBH-001.

Insecticides which may cause damage to plants when used on their own or together with herbicides are, for example, the following: Organophosphates, for example terbufos (Counter®), fonofos (Dyfonate®), phorate (Thimet®), chlorpyriphos (Reldan®), carbamates, such as carbofuran (Furadan®), pyrethroid insecticides, such as tefluthrin (Force®), deltamethrin (Decis®) and tralomethrin (Scout®), and other insecticidal agents having a different mechanism of action.

Herbicides, whose phytotoxic side effects on crop plants can be reduced using compounds of the formula (I) are, for example, herbicides from the group of the carbamates, thiocarbamates, haloacetanilides, substituted phenoxy-, naphthoxy- and phenoxyphenoxycarboxylic acid derivatives and heteroaryloxyphenoxyalkanecarboxylic acid derivatives, such as quinolyloxy-, quinoxalyloxy-, pyridyloxy-, benzoxazolyloxy- and benzothiazolyloxyphenoxyalkanecarboxylic acid esters, cyclohexanedione oximes, benzoylcyclohexanediones, benzoylisoxazoles, benzoylpyrazoles, imidazolinones, pyrimidinyloxypyridinecarboxylic acid derivatives, pyrimidyloxybenzoic acid derivatives, sulfonylureas, sulfonylaminocarbonyltriazolinones, triazolopyrimidinesulfonamide derivatives, phosphinic acid derivatives and salts thereof, glycine derivatives, triazolinones, triazinones and also S—(N-aryl-Nalkylcarbamoylmethyl)dithiophosphoric esters, pyridinecarboxylic acids, pyridines, pyridinecarboxamides, 1,3,5-triazines and others.

Preference is given here to phenoxyphenoxy- and heteroaryloxyphenoxycarboxylic acid esters and salts, cyclohexanedione oximes, benzoylcyclohexanediones, benzoylisoxazoles, benzoylpyrazoles, sulfonylureas, sulfonylaminocarbonyltriazolinones, imidazolinones and mixtures of the active compounds mentioned with one another and/or with active compounds used for broadening the activity spectrum of the herbicides, for example bentazone, cyanazine, atrazine, bromoxynil, dicamba and other leaf-acting herbicides.

Herbicides which are suitable for combination with the safeners according to the invention are, for example, those of Table 2 below:

### Table 2: Preferred Co-Components for Safeners (I) (Classified According to Structural Classes)

A) herbicides of the type of the phenoxyphenoxy- and heteroaryloxyphenoxycarboxylic acid derivatives, such as
A1) phenoxyphenoxy- and benzyloxyphenoxycarboxylic acid derivatives, for example methyl 2-(4-(2,4-dichlorophenoxy)phenoxy)propionate (diclofop-methyl),
methyl 2-(4-(4-bromo-2-chlorophenoxy)phenoxy)propionate (DE-A 26 01 548 (U.S. Pat. No. 4,370,489)),
methyl 2-(4-(4-bromo-2-fluorophenoxy)phenoxy)propionate (U.S. Pat. No. 4,808,750),
methyl 2-(4-(2-chloro-4-trifluoromethylphenoxy)phenoxy)propionate (DE-A 24 33 067 (U.S. Pat. No. 4,332,960)),
methyl 2-(4-(2-fluoro-4-trifluoromethylphenoxy)phenoxy)propionate (U.S. Pat. No. 4,808,750),
methyl 2-(4-(2,4-dichlorobenzyl)phenoxy)propionate (DE-A 24 17 487 (U.S. Pat. No. 4,088,474)),
ethyl 4-(4-(4-trifluoromethylphenoxy)phenoxy)pent-2-enoate,
methyl 2-(4-(4-trifluoromethylphenoxy)phenoxy)propionate (DE-A 24 33 067),
butyl (R)-2-[4-(4-cyano-2-fluorophenoxy)phenoxy]propionate (cyhalofop-butyl)
   A2) “monocyclic” heteroaryloxyphenoxyalkanecarboxylic acid derivatives, for example
ethyl 2-(4-(3,5-dichloropyridyl-2-oxy)phenoxy)propionate (EP-A 0 002 925),
propargyl 2-(4-(3,5-dichloropyridyl-2-oxy)phenoxy)propionate (EP-A 0 003 114 (U.S. Pat. No. 4,300,944)),
methyl (RS)- or (R)-2-(4-(3-chloro-5-trifluoromethyl-2-pyridyloxy)phenoxy)propionate (haloxyfop-methyl or haloxyfop-P-methyl),
ethyl 2-(4-(3-chloro-5-trifluoromethyl-2-pyridyloxy)phenoxy)propionate (EP-A 0 003 890 (U.S. Pat. No. 4,840,664)),
propargyl 2-(4-(5-chloro-3-fluoro-2-pyridyloxy)phenoxy)propionate (clodinafop-propargyl),
butyl (RS)- or (R)-2-(4-(5-trifluoromethyl-2-pyridyloxy)phenoxy)propionate (fluazifop-butyl or fluazifop-P-butyl),
(R)-2-[4-(3-chloro-5-trifluoromethyl-2-pyridyloxy)phenoxy]propionic acid
   A3) “bicyclic” heteroaryloxyphenoxyalkanecarboxylic acid derivatives, for example
methyl and ethyl (RS)- or (R)-2-(4-(6-chloro-2-quinoxalyloxy)phenoxy)propionate (quizalofop-methyl and -ethyl or quizalofop-P-methyl and -P-ethyl),
methyl 2-(4-(6-fluoro-2-quinoxalyloxy)phenoxy)propionate (see J. Pest. Sci. Vol. 10, 61 (1985)),
2-isopropylideneaminooxyethyl (R)-2-(4-(6-chloro-2-quinoxalyloxy)phenoxy)propionate (propaquizafop),
ethyl (RS)- or (R)-2-(4-(6-chlorobenzoxazol-2-yloxy)phenoxy)propionate (fenoxaprop-ethyl or fenoxaprop-P-ethyl),
ethyl 2-(4-(6-chlorobenzthiazol-2-yloxy)phenoxy)propionate (DE-A-26 40 730 (U.S. Pat. No. 4,130,413)),
tetrahydro-2-furylmethyl (RS)- or (R)-2-(4-(6-chloroquinoxalyloxy)phenoxy) propionate (EP-A-0 323 727 (U.S. Pat. No. 5,120,348);
(R)-2-[4-(6-chloro-1,3-benzoxazol-2-yloxy)phenoxy]-2′-fluoro-N-methylpropionanilide (metamifop);
   B) herbicides from the group of the sulfonylureas, such as pyrimidinyl- or triazinylaminocarbonyl[benzene-, -pyridine-, -pyrazole-, -thiophene- and -(alkylsulfonyl)alkylamino]sulfamides. Preferred substituents on the pyrimidine ring or the triazine ring are alkoxy, alkyl, haloalkoxy, haloalkyl, halogen or dimethylamino, it being possible to combine all substituents independently of one another. Preferred substituents in the benzene, pyridine, pyrazole, thiophene or (alkylsulfonyl)alkylamino moiety are alkyl, alkoxy, halogen, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, (alkanesulfonyl)alkylamino. Such suitable sulfonylureas are, for example,
   B1) phenyl- and benzylsulfonylureas and related compounds, for example
1-(2-chlorophenylsulfonyl)-3-(4-methoxy-6-methyl-1,3,5-triazin-2-yl)urea (chlorsulfuron),
1-(2-ethoxycarbonylphenylsulfonyl)-3-(4-chloro-6-methoxypyrimidin-2-yl)urea (chlorimuron-ethyl),
1-(2-methoxyphenylsulfonyl)-3-(4-methoxy-6-methyl-1,3,5-triazin-2-yl)urea (metsulfuron-methyl),
1-(2-chloroethoxyphenylsulfonyl)-3-(4-methoxy-6-methyl-1,3,5-triazin-2-yl)urea (triasulfuron),
1-(2-methoxycarbonylphenysulfonyl)-3-(4,6-dimethylpyrimidin-2-yl)urea (sulfometuron-methyl),
1-(2-methoxycarbonylphenylsulfonyl)-3-(4-methoxy-6-methyl-1,3,5-triazin-2-yl)-3-methylurea (tribenuron-methyl),
1-(2-methoxycarbonyl benzylsulfonyl)-3-(4,6-dimethoxypyrimidin-2-yl)urea (bensulfuron-methyl),
1-(2-methoxycarbonylphenysulfonyl)-3-(4,6-bis-(difluoromethoxy)pyrimidin-2-yl)urea (primisulfuron-methyl),
3-(4-ethyl-6-methoxy-1,3,5-triazin-2-yl)-1-(2,3-dihydro-1,1-dioxo-2-methylbenzo[b]-thiophene-7-sulfonyl)urea (EP-A 0 079 683 (U.S. Pat. No. 4,492,596)),
3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),
3-(4-methoxy-6-methyl-1,3,5-triazin-2-yl)-1-(2-methoxycarbonyl-5-iodophenylsulfonyl)urea (WO 92/13845 (U.S. Pat. No. 5,463,081)),
methyl 2-[4-dimethylamino-6-(2,2,2-trifluoroethoxy)-1,3,5-triazin-2-ylcarbamoylsulfamoyl]-3-methylbenzoate (DPX-66037, triflusulfuron-methyl),
oxetan-3-yl 2-[(4,6-dimethylpyrimidin-2-yl)carbamoylsulfamoyl]benzoate (CGA-277476, oxasulfuron),
methyl 4-iodo-2-[3-(4-methoxy-6-methyl-1,3,5-triazin-2-yl)ureidosulfonyl]benzoate, sodium salt (iodosulfuron-methyl-sodium),
methyl 2-[3-(4,6-dimethoxypyrimidin-2-yl)ureidosulfonyl]-4-methanesulfonylaminomethylbenzoate (mesosulfuron-methyl, WO 95/10507 (U.S. Pat. No. 5,648,315)),
N,N-dimethyl-2-[3-(4,6-dimethoxypyrimidin-2-yl)ureidosulfonyl]-4-formylaminobenzamide (foramsulfuron, WO 95/01344 (U.S. Pat. No. 5,658,854)),
1-(4,6-dimethoxy-1,3,5-triazin-2-yl)-3-[2-(2-methoxyethoxy)phenylsulfonyl]urea (cinosulfuron),
methyl 2-[(4-ethoxy-6-methylamino-1,3,5-triazin-2-yl)carbamoylsulfamoyl]benzoate (ethametsulfuron-methyl),
1-(4-methoxy-6-methyl-1,3,5-triazin-2-yl)-3-[2-(3,3,3-trifluoropropyl)phenylsulfonyl]-urea (prosulfuron),
1-(4-methoxy-6-trifluoromethyl-1,3,5-triazin-2-yl)-3-(2-trifluoromethylbenzenesulfonyl)urea (tritosulfuron),
N-[(4-methylpyrimidin-2-yl)carbamoyl]-2-nitrobenzenesulfonamide (monosulfuron), methyl 2-[({[methoxy-6-(methylthio)pyrimidin-2-yl]carbamoyl}amino)sulfonyl]benzoate,
   B2) thienylsulfonylureas, for example
1-(2-methoxycarbonylthiophen-3-yl)-3-(4-methoxy-6-methyl-1,3,5-triazin-2-yl)urea (thifensulfuron-methyl);
   B3) pyrazolylsulfonylureas, for example
1-(4-ethoxycarbonyl-1-methylpyrazol-5-ylsulfonyl)-3-(4,6-dimethoxypyrimidin-2-yl)urea (pyrazosulfuron-ethyl),
methyl 3-chloro-5-(4,6-dimethoxypyrimidin-2-ylcarbamoylsulfamoyl)-1-methylpyrazole-4-carboxylate (halosulfuron-methyl),
methyl 5-(4,6-dimethylpyrimidin-2-yl-carbamoylsulfamoyl)-1-(2-pyridyl)pyrazole-4-carboxylate (NC-330, see Brighton Crop Prot. Conference ‘Weeds’ 1991, Vol. 1, p. 45 et seq.),
1-(4,6-dimethoxypyrimidin-2-yl)-3-[1-methyl-4-(2-methyl-2H-tetrazol-5-yl)pyrazol-5-ylsulfonyl]urea (DPX-A8947, azimsulfuron);
N-[(4,6-dimethoxypyrimidin-2-yl)carbamoyl]-4-(5,5-dimethyl-4,5-dihydroisoxazol-3-yl)-1,3-dimethyl-1H-pyrazole-5-sulfonamide;
   B4) sulfonediamide derivatives, for example
3-(4,6-dimethoxypyrimidin-2-yl)-1-(N-methyl-N-methylsulfonylaminosulfonyl)urea (amidosulfuron) and its structural analogs (EP-A 0 131 258 (U.S. Pat. No. 4,601,747) and Z. Pfl. Krankh. Pfl. Schutz, special issue XII, 489-497 (1990));
   B5) pyridylsulfonylureas, for example
1-(3-N,N-dimethylaminocarbonylpyridin-2-ylsulfonyl)-3-(4,6-dimethoxypyrimidin-2-yl)urea (nicosulfuron),
1-(3-ethylsulfonylpyridin-2-ylsulfonyl)-3-(4,6-dimethoxypyrimidin-2-yl)urea (rimsulfuron),
methyl 2-[3-(4,6-dimethoxypyrimidin-2-yl)ureidosulfonyl]-6-trifluoromethyl-3-pyridinecarboxylate, sodium salt (DPX-KE 459, flupyrsulfuron-methyl-sodium),
3-(4,6-dimethoxypyrimidin-2-yl)-1-(3-N-methylsulfonyl-N-methylaminopyridin-2-yl)sulfonylurea or its salts (DE-A 40 00 503 (U.S. Pat. No. 5,494,886) and DE-A 40 30 577),
1-(4,6-dimethoxypyrimidin-2-yl)-3-(3-trifluoromethyl-2-pyridylsulfonyl)urea (flazasulfuron),
1-(4,6-dimethoxypyrimidin-2-yl)-3-[3-(2,2,2-trifluoroethoxy)-2-pyridylsulfonyl]urea sodium salt (trifloxysulfuron-sodium);
(1RS,2RS;1RS,2SR)-1-{3-[(4,6-dimethoxypyrimidin-2-ylcarbamoyl)sulfamoyl]-2-pyridyl}-2-fluoropropyl methoxyacetate (flucetosulfuron);
   B6) alkoxyphenoxysulfonylureas, for example
3-(4,6-dimethoxypyrimidin-2-yl)-1-(2-ethoxyphenoxy)sulfonylurea or its salts (ethoxysulfuron);
   B7) imidazolylsulfonylureas, for example
1-(4,6-dimethoxypyrimidin-2-yl)-3-(2-ethylsulfonylimidazo[1,2-a]pyridin-3-yl)sulfonylurea (MON 37500, sulfosulfuron),
1-(2-chloroimidazo[1,2-a]pyridin-3-ylsulfonyl)-3-(4,6-dimethoxypyrimidin-2-yl)urea (imazosulfuron);
2-chloro-N-[(4,6-dimethoxypyrimidin-2-yl)carbamoyl]-6-propylimidazo[1,2-b]pyridazine-3-sulfonamide;
   B8) phenylaminosulfonylureas, for example
1-[2-(cyclopropylcarbonyl)phenylaminosulfonyl]-3-(4,6-dimethoxypyrimidin-2-yl)urea (cyclosulfamuron);
1-dimethoxypyrimidin-2-yl)-3-[2-(dimethylcarbamoyl)phenylsulfamoyl]urea (orthosulfamuron);
   C) chloroacetanilides, for example
acetochlor, alachlor, butachlor, dimethachlor, dimethenamid, dimethanamid-P metazachlor,
metolachlor, S-metolachlor, pethoxamid, pretilachlor, propachlor, propisochlor and thenylchlor;
   D) thiocarbamates, for example
S-ethyl N,N-dipropylthiocarbamate (EPTC),
S-ethyl N,N-diisobutylthiocarbamate (butylate);
cycloate, dimepiperate, esprocarb, molinate, orbencarb, pebulate, prosulfocarb, thiobencarb, tiocarbazil, tri-allate and vernolate;

E) cyclohexanedione oximes, for example
alloxydim, butroxydim, clethodim, cloproxydim, cycloxydim, profoxydim, sethoxydim, tepraloxydim and tralkoxydim;

F) imidazolinones, for example
imazamethabenz-methyl, imazapic, imazamox, imazapyr, imazaquin and imazethapyr;

G) triazolopyrimidinesulfonamide derivatives, for example
chloransulam-methyl, diclosulam, florasulam, flumetsulam, metosulam, penoxsulam, i.e. 2-(2,2-difluoroethoxy)-N-(5,8-dimethoxy[1,2,4]triazolo[1,5-c]pyrimidin-2-yl)-6-(trifluoromethyl)benzenesulfonamide, and pyroxsulam, i.e. N-(5,7-dimethoxy[1,2,4]triazolo[1,5-a]pyrimidin-2-yl)-2-methoxy-4-(trifluoromethyl)-3-pyridinesulfonamide;
   H) benzoylcyclohexanediones, for example
2-(2-chloro-4-methylsulfonylbenzoyl)cyclohexane-1,3-dione (SC-0051, sulcotrione),
2-(2-nitrobenzoyl)-4,4-dimethylcyclohexane-1,3-dione (EP-A 0 274 634),
2-(2-nitro-3-methylsulfonylbenzoyl)-4,4-dimethylcyclohexane-1,3-dione (WO 91/13548),
2-[4-(methylsulfonyl)-2-nitrobenzoyl]-1,3-cyclohexanedione (mesotrione)
2-[2-chloro-3-(5-cyanomethyl-4,5-dihydroisoxazol-3-yl)-4-(ethylsulfonyl)benzoyl]-1,3-cyclohexanedione,
2-[2-chloro-3-(5-cyanomethyl-4,5-dihydroisoxazol-3-yl)-4-(methylsulfonyl)benzoyl]-1,3-cyclohexanedione,
2-[2-chloro-3-(5-ethoxymethyl-4,5-dihydroisoxazol-3-yl)-4-(ethylsulfonyl)benzoyl]-1,3-cyclohexanedione,
2-[2-chloro-3-(5-ethoxymethyl-4,5-dihydroisoxazol-3-yl)-4-(methylsulfonyl)benzoyl]-1,3-cyclohexanedione,
2-[2-chloro-3-[(2,2,2-trifluoroethoxy)methyl]-4-(ethylsulfonyl)benzoyl]-1,3-cyclohexanedione,
2-[2-chloro-3-[(2,2,2-trifluoroethoxy)methyl]-4-(methylsulfonyl)benzoyl]-1,3-cyclohexanedione (tembotrione),
2-[2-chloro-3-[(2,2-difluoroethoxy)methyl]-4-(ethylsulfonyl)benzoyl]-1,3-cyclohexanedione,
2-[2-chloro-3-[(2,2-difluoroethoxy)methyl]-4-(methylsulfonyl)benzoyl]-1,3-cyclohexanedione,
2-[2-chloro-3-[(2,2,3,3-tetrafluoropropoxy)methyl]-4-(ethylsulfonyl)benzoyl]-1,3-cyclohexanedione,
2-[2-chloro-3-[(2,2,3,3-tetrafluoropropoxy)methyl]-4-(methylsulfonyl)benzoyl]-1,3-cyclohexanedione,
2-[2-chloro-3-(cyclopropylmethoxy)-4-(ethylsulfonyl)benzoyl]-1,3-cyclohexanedione,
2-[2-chloro-3-(cyclopropylmethoxy)-4-(methylsulfonyl)benzoyl]-1,3-cyclohexanedione,
2-[2-chloro-3-(tetrahydrofuran-2-ylmethoxymethyl)-4-(ethylsulfonyl)benzoyl]-1,3-cyclohexanedione,
2-[2-chloro-3-(tetrahydrofuran-2-ylmethoxymethyl)-4-(methylsulfonyl)benzoyl]-1,3-cyclohexanedione (tefuryltrione),
2-[2-chloro-3-[2-(2-methoxyethoxy)ethoxymethyl]-4-(ethylsulfonyl)benzoyl]-1,3-cyclohexanedione,
2-[2-chloro-3-[2-(2-methoxyethoxy)ethoxymethyl]-4-(methylsulfonyl)benzoyl]-1,3-cyclohexanedione,
3-({2-[(2-methoxyethoxy)methyl]-6-(trifluoromethyl)pyridin-3-yl}carbonyl)bicyclo[3.2.1]octane-2,4-dione (WO 2001-094339 (U.S. Pat. No. 6,838,564));
   I) benzoylisoxazoles, for example
5-cyclopropyl-[2-(methylsulfonyl)-4-(trifluoromethyl)benzoyl]isoxazole (isoxaflutole);
(4-chloro-2-mesylphenyl)(5-cyclopropyl-1,2-oxazol-4-yl)methanone (isoxachlortole);
   J) benzoylpyrazoles, for example
2-[4-(2,4-dichloro-m-toluoyl)-1,3-dimethylpyrazol-5-yloxy]-4′-methylacetophenone (benzofenap),
4-(2,4-dichlorobenzoyl)-1,3-dimethylpyrazol-5-yl toluene-4-sulfonate (pyrazolynate),
2-[4-(2,4-dichlorobenzoyl)-1,3-dimethylpyrazol-5-yloxy]acetophenone (pyrazoxyfen);
5-hydroxy-1-methyl-4-[2-(methylsulfonyl)-4-trifluoromethylbenzoyl]pyrazole (WO 01/74785 (U.S. Pat. No. 6,420,317),
1-ethyl-5-hydroxy-4-[2-(methylsulfonyl)-4-trifluoromethylbenzoyl]pyrazole (WO 01/74785),
1,3-dimethyl-5-hydroxy-4-[2-(methylsulfonyl)-4-trifluoromethylbenzoyl]pyrazole (WO 01/74785),
1-ethyl-5-hydroxy-3-methyl-4-[2-(methylsulfonyl)-4-trifluoromethylbenzoyl]pyrazole (pyrasulfotole, WO 01/74785),
5-hydroxy-1-methyl-4-[-2-chloro-3-(4,5-dihydroisoxazol-3-yl)-4-methylsulfonylbenzoyl]pyrazole (WO 99/58509 (U.S. Pat. No. 6,525,204)),
5-hydroxy-1-methyl-4-[3-(4,5-dihydroisoxazol-3-yl)-2-methyl-4-methylsulfonylbenzoyl]pyrazole (topramezone, WO 99/58509),
1-ethyl-5-hydroxy-3-methyl-4-[2-methyl-4-methylsulfonyl-3-(2-methoxyethylamino)benzoyl]pyrazole (WO 96/26206 (U.S. Pat. No. 5,846,907)),
3-cyclopropyl-5-hydroxy-1-methyl-4-[2-methyl-4-methylsulfonyl-3-(2-methoxyethylamino)benzoyl]pyrazole (WO 96/26206),
5-benzoxy-1-ethyl-4-[2-methyl-4-methylsulfonyl-3-(2-methoxyethylamino)benzoyl]-pyrazole (WO 96/26206),
1-ethyl-5-hydroxy-4-(3-dimethylamino-2-methyl-4-methylsulfonylbenzoyl)pyrazole (WO 96/26206),
5-hydroxy-1-methyl-4-(2-chloro-3-dimethylamino-4-methylsulfonylbenzoyl)pyrazole (WO 96/26206),
1-ethyl-5-hydroxy-4-(3-allylamino-2-chloro-4-methylsulfonylbenzoyl)pyrazole (WO 96/26206),
1-ethyl-5-hydroxy-4-(2-methyl-4-methylsulfonyl-3-morpholinobenzoyl)pyrazole (WO 96/26206),
5-hydroxy-1-isopropyl-4-(2-chloro-4-methylsulfonyl-3-morpholinobenzoyl)pyrazole (WO 96/26206),
3-cyclopropyl-5-hydroxy-1-methyl-4-(2-chloro-4-methylsulfonyl-3-morpholinobenzoyl)pyrazole (WO 96/26206),
1,3-dimethyl-5-hydroxy-4-(2-chloro-4-methylsulfonyl-3-pyrazol-1-ylbenzoyl)pyrazole (WO 96/26206),
1-ethyl-5-hydroxy-3-methyl-4-(2-chloro-4-methylsulfonyl-3-pyrazol-1-ylbenzoyl)pyrazole (WO 96/26206),
1-ethyl-5-hydroxy-4-(2-chloro-4-methylsulfonyl-3-pyrazol-1-ylbenzoyl)pyrazole (WO 96/26206),
(5-hydroxy-1-methyl-1H-pyrazol-4-yl)(3,3,4-trimethyl-1,1-dioxido-2,3-dihydro-1-benzothien-5-yl)methanone (US2002/0016262),
1-methyl-4-[(3,3,4-trimethyl-1,1-dioxido-2,3-dihydro-1-benzothien-5-yl)carbonyl]-1H-pyrazol-5-ylpropane-1-sulfonate (US2002/0016262, WO 2002/015695 (US 2002052296));
3-(2-chloro-4-mesylbenzoyl)-2-phenylthiobicyclo[3.2.1]oct-2-en-4-one (benzobicyclon);
   K) sulfonylaminocarbonyltriazolinones, for example
4,5-dihydro-3-methoxy-4-methyl-5-oxo-N-(2-trifluoromethoxyphenylsulfonyl)-1H-1,2,4-triazole-1-carboxamide sodium salt (flucarbazone-sodium),
methyl 2-(4,5-dihydro-4-methyl-5-oxo-3-propoxy-1H-1,2,4-triazol-1-yl)carboxamidosulfonylbenzoate sodium salt (propoxycarbazone-Na);
methyl 4-[(4,5-dihydro-3-methoxy-4-methyl-5-oxo-1H-1,2,4-triazol-1-yl)carbonylsulfamoyl]-5-methylthiophene-3-carboxylate (thiencarbazone-methyl);
   L) triazolinones, for example
4-amino-N-tert-butyl-4,5-dihydro-3-isopropyl-5-oxo-1,2,4-1H-triazole-1-carboxamide (amicarbazone),
2-(2,4-dichloro-5-prop-2-ynyloxyphenyl)-5,6,7,8-tetrahydro-1,2,4-triazolo[4,3-a]-pyridin-3(2H)-one (azafenidin),
ethyl (RS)-2-chloro-3-[2-chloro-5-(4-difluoromethyl-4,5-dihydro-3-methyl-5-oxo-1H-1,2,4-triazol-1-yl)-4-fluorophenyl]propionate (carfentrazone-ethyl),
2′,4′-dichloro-5′-(4-difluoromethyl-4,5-dihydro-3-methyl-5-oxo-1H-1,2,4-triazol-1-yl)methanesulfonanilide (sulfentrazone);
4-[4,5-dihydro-4-methyl-5-oxo-3-(trifluoromethyl)-1H-1,2,4-triazol-1-yl]-2-[(ethylsulfonyl)amino]-5-fluorobenzenecarbothioamide (bencarbazone);
   M) phosphinic acids and derivatives, for example
4-[hydroxy(methyl)phosphinoyl]-L-homoalanyl-L-alanyl-L-alanine (bilanafos),
DL-homoalanin-4-yl(methyl)phosphinic acid ammonium salt (glufosinateammonium);
   N) glycine derivatives, for example
N-(phosphonomethyl)glycine and its salts (glyphosate and salts, for example the sodium salt or the isopropylammonium salt),
N-(phosphonomethyl)glycine trimesium salt (sulfosate);
   O) pyrimidinyloxypyridinecarboxylic acid derivatives and pyrimidinyloxybenzoic acid derivatives, for example
benzyl 3-(4,6-dimethoxypyrimidin-2-yl)oxypyridine-2-carboxylate (EP-A 0 249 707 (U.S. Pat. No. 4,832,729)),
methyl 3-(4,6-dimethoxypyrimidin-2-yl)oxypyridine-2-carboxylate (EP-A 0 249 707),
1-(ethoxycarbonyloxyethyl) 2,6-bis[(4,6-dimethoxypyrimidin-2-yl)oxy]benzoate (EP-A 0 472 113 (U.S. Pat. No. 5,154,750)),
2,6-bis[(4,6-dimethoxypyrimidin-2-yl)oxy]benzoic acid (bispyribac-sodium),
isopropyl 4-[[[2-[(4,6-dimethoxy-2-pyrimidinyl)oxy]phenyl]methyl]amino]benzoate (pyribambenz-isopropyl, WO 2002034724 (U.S. Pat. No. 6,800,590)),
propyl 4-[[[2-[(4,6-dimethoxy-2-pyrimidinyl)oxy]phenyl]methyl]amino]benzoate (pyribambenz-propyl, WO 2002034724),
pyribenzoxim, pyriftalid, pyriminobac-methyl, pyrithiobac-sodium, pyrimisulfan;
   P) S—(N-aryl-N-alkylcarbamoylmethyl)dithiophosphonic acid esters, such as S—[N-(4-chlorophenyl)-N-isopropylcarbamoylmethyl] O,O-dimethyl dithiophosphate (anilophos);
   Q) triazinones, for example
3-cyclohexyl-6-dimethylamino-1-methyl-1,3,5-triazine-2,4-(1H,3H)-dione (hexazinone),
4-amino-4,5-dihydro-3-methyl-6-phenyl-1,2,4-triazin-5-one (metamitron),
4-amino-6-tert-butyl-4,5-dihydro-3-methylthio-1,2,4-triazin-5-one (metribuzin);
   R) pyridinecarboxylic acids, for example
aminopyralid, clopyralid, fluoroxypyr, picloram and triclopyr;
   S) pyridines, for example
dithiopyr and thiazopyr;
   T) pyridinecarboxamides, for example
diflufenican and picolinafen;
   U) 1,3,5-triazines, for example
ametryn, atrazine, cyanazine, dimethametrin, prometon, prometryn, propazine, simazine, symetryn, terbumeton, terbuthylazine, terbutryn and trietazine;
   V) plant growth regulators, for example
forchlorfenuron and thidiazuron;
   W) ketoenoles, for example
8-(2,6-diethyl-p-tolyl)-1,2,4,5-tetrahydro-7-oxo-7H-pyrazolo[1,2-d][1,4,5]oxadiazepin-9-yl 2,2-dimethylpropionate (pinoxaden);
   X) pyrazoles, for example
3-[5-(difluoromethoxy)-1-methyl-3-(trifluoromethyl)pyrazol-4-ylmethylsulfonyl]-4,5-dihydro-5,5-dimethyl-1,2-oxazole (pyroxasulfone).

The herbicides of groups A to X are known, for example, from the respective abovementioned publications and from “The Pesticide Manual”, The British Crop Protection Council, 14th Edition, 2006, or the e-Pesticide Manual, Version 4.0, British Crop Protection Council 2006 or else from the “Compendium of Pesticide Common Names”.

Some of the herbicides, listed above according to structural types, also share structure-overlapping characteristics when it comes to their mechanism of action, and some are also similar to one another with respect to their behaviour in the combinations with the safeners (I).

Suitable herbicides which can be combined with the safeners according to the invention are, for example, those from Table 3 below:

TABLE 3
Groups of herbicides and herbicides, classified according to
mechanism of action or phenomenology of action

| | |
|---|---|
| (1) | Herbicides whose harmful action develops over a period of several |
| | days or weeks, for example |
| (1.1) | herbicides which prevent or inhibit the formation of chlorophyll |
| | (herbicides acting as bleachers), for example |
| (1.1.1) | inhibitors of hydroxyphenylpyruvate dioxygenase (HPPD inhibitors), |
| | such as |
| (1.1.1.1) | 2-(2-chloro-4-methylsulfonylbenzoyl)cyclohexane-1,3-dione (SC-0051, |
| | sulcotrione), |
| (1.1.1.2) | 2-(2-nitrobenzoyl)-4,4-dimethylcyclohexane-1,3-dione (EP-A |
| | 0 274 634), |
| (1.1.1.3) | 2-(2-nitro-3-methylsulfonylbenzoyl)-4,4-dimethylcyclohexane-1,3-dione |
| | (WO 91/13548), |
| (1.1.1.4) | 2-[4-(methylsulfonyl)-2-nitrobenzoyl]-1,3-cyclohexanedione |
| | (mesotrione), |
| (1.1.1.5) | 2-[2-chloro-3-(5-cyanomethyl-4,5-dihydroisoxazol-3-yl)-4- |
| | (ethylsulfonyl)benzoyl]-1,3-cyclohexanedione, |
| (1.1.1.6) | 2-[2-chloro-3-(5-cyanomethyl-4,5-dihydroisoxazol-3-yl)-4- |
| | (methylsulfonyl)benzoyl]-1,3-cyclohexanedione, |
| (1.1.1.7) | 2-[2-chloro-3-(5-ethoxymethyl-4,5-dihydroisoxazol-3-yl)-4- |
| | (ethylsulfonyl)benzoyl]-1,3-cyclohexanedione, |
| (1.1.1.8) | 2-[2-chloro-3-(5-ethoxymethyl-4,5-dihydroisoxazol-3-yl)-4- |
| | (methylsulfonyl)benzoyl]-1,3-cyclohexanedione, |
| (1.1.1.9) | 2-[2-chloro-3-[(2,2,2-trifluoroethoxy)methyl]-4-(ethylsulfonyl)benzoyl]- |
| | 1,3-cyclohexanedione, |
| (1.1.1.10) | 2-[2-chloro-3-[(2,2,2-trifluoroethoxy)methyl]-4-(methylsulfonyl)benzoyl]- |
| | 1,3-cyclohexanedione (tembotrione), |
| (1.1.1.11) | 2-[2-chloro-3-[(2,2-difluoroethoxy)methyl]-4-(ethylsulfonyl)benzoyl]-1,3- |
| | cyclohexanedione, |
| (1.1.1.12) | 2-[2-chloro-3-[(2,2-difluoroethoxy)methyl]-4-(methylsulfonyl)benzoyl]- |
| | 1,3-cyclohexanedione, |
| (1.1.1.13) | 2-[2-chloro-3-[(2,2,3,3-tetrafluoropropoxy)methyl]-4-(ethylsulfonyl)- |
| | benzoyl]-1,3-cyclohexanedione, |
| (1.1.1.14) | 2-[2-chloro-3-[(2,2,3,3-tetrafluoropropoxy)methyl]-4-(methylsulfonyl)- |
| | benzoyl]-1,3-cyclohexanedione, |
| (1.1.1.15) | 2-[2-chloro-3-(cyclopropylmethoxy)-4-(ethylsulfonyl)benzoyl]-1,3- |
| | cyclohexanedione, |
| (1.1.1.16) | 2-[2-chloro-3-(cyclopropylmethoxy)-4-(methylsulfonyl)benzoyl]-1,3- |
| | cyclohexanedione, |
| (1.1.1.17) | 2-[2-chloro-3-(tetrahydrofuran-2-ylmethoxymethyl)-4-(ethylsulfonyl)- |
| | benzoyl]-1,3-cyclohexanedione, |
| (1.1.1.18) | 2-[2-chloro-3-(tetrahydrofuran-2-ylmethoxymethyl)-4-(methylsulfonyl)- |
| | benzoyl]-1,3-cyclohexanedione (tefuryltrione), |
| (1.1.1.19) | 2-[2-chloro-3-[2-(2-methoxyethoxy)-ethoxymethyl]-4-(ethylsulfonyl)- |
| | benzoyl]-1,3-cyclohexanedione, |
| (1.1.1.20) | 2-[2-chloro-3-[2-(2-methoxyethoxy)-ethoxymethyl]-4-(methylsulfonyl)- |
| | benzoyl]-1,3-cyclohexanedione, |
| (1.1.1.21) | 3-({2-[(2-methoxyethoxy)methyl]-6-(trifluoromethyl)pyridin-3- |
| | yl}carbonyl)bicyclo[3.2.1]octane-2,4-dione (WO 2001094339) |
| (1.1.1.22) | 5-cyclopropyl-[2-(methylsulfonyl)-4-(trifluoromethyl)benzoyl]isoxazole |
| | (isoxaflutole); |
| (1.1.1.23) | 2-[4-(2,4-dichloro-m-toluoyl)-1,3-dimethylpyrazol-5-yloxy]-4′- |
| | methylacetophenone (benzofenap), |
| (1.1.1.24) | 4-(2,4-dichlorobenzoyl)-1,3-dimethylpyrazol-5-yltoluene-4-sulfonate |
| | (pyrazolynate), |
| (1.1.1.25) | 2-[4-(2,4-dichlorobenzoyl)-1,3-dimethylpyrazol-5-yloxy]acetophenone |
| | (pyrazoxyfen); |
| (1.1.1.26) | 5-hydroxy-1-methyl-4-[2-(methylsulfonyl)-4-trifluoromethylbenzoyl]- |
| | pyrazole (WO 01/74785), |
| (1.1.1.27) | 1-ethyl-5-hydroxy-4-[2-(methylsulfonyl)-4-trifluoromethylbenzoyl]- |
| | pyrazole (WO 01/74785), |
| (1.1.1.28) | 1,3-dimethyl-5-hydroxy-4-[2-(methylsulfonyl)-4-trifluoromethyl- |
| | benzoyl]pyrazole (WO 01/74785), |
| (1.1.1.29) | 1-ethyl-5-hydroxy-3-methyl-4-[2-(methylsulfonyl)-4-trifluoromethyl- |
| | benzoyl]pyrazole (pyrasulfotole, WO 01/74785), |
| (1.1.1.30) | 5-hydroxy-1-methyl-4-[-2-chloro-3-(4,5-dihydroisoxazol-3-yl)-4- |
| | methylsulfonylbenzoyl]pyrazole (WO 99/58509), |
| (1.1.1.31) | 5-hydroxy-1-methyl-4-[3-(4,5-dihydroisoxazol-3-yl)-2-methyl-4- |
| | methylsulfonylbenzoyl]pyrazole (WO 99/58509), |
| (1.1.1.32) | 1-ethyl-5-hydroxy-3-methyl-4-[2-methyl-4-methylsulfonyl-3-(2-methoxy- |
| | ethylamino)benzoyl]pyrazole (topramezone, WO 96/26206), |
| (1.1.1.33) | 3-cyclopropyl-5-hydroxy-1-methyl-4-[2-methyl-4-methylsulfonyl-3-(2- |
| | methoxyethylamino)benzoyl]pyrazole (WO 96/26206), |
| (1.1.1.34) | 5-benzoxy-1-ethyl-4-[2-methyl-4-methylsulfonyl-3-(2-methoxy- |
| | ethylamino)benzoyl]pyrazole (WO 96/26206), |
| (1.1.1.35) | 1-ethyl-5-hydroxy-4-(3-dimethylamino-2-methyl-4-methylsulfonyl- |
| | benzoyl)pyrazole (WO 96/26206), |
| (1.1.1.36) | 5-hydroxy-1-methyl-4-(2-chloro-3-dimethylamino-4-methylsulfonyl- |
| | benzoyl)pyrazole (WO 96/26206), |
| (1.1.1.37) | 1-ethyl-5-hydroxy-4-(3-allylamino-2-chloro-4-methylsulfonylbenzoyl)- |
| | pyrazole (WO 96/26206), |
| (1.1.1.38) | 1-ethyl-5-hydroxy-4-(2-methyl-4-methylsulfonyl-3-morpholinobenzoyl- |
| | pyrazole (WO 96/26206), |
| (1.1.1.39) | 5-hydroxy-1-isopropyl-4-(2-chloro-4-methylsulfonyl-3-morpholino- |
| | benzoyl)pyrazole (WO 96/26206), |
| (1.1.1.40) | 3-cyclopropyl-5-hydroxy-1-methyl-4-(2-chloro-4-methylsulfonyl-3- |
| | morpholinobenzoyl)pyrazole (WO 96/26206), |
| (1.1.1.41) | 1,3-dimethyl-5-hydroxy-4-(2-chloro-4-methylsulfonyl-3-pyrazol-1-yl- |
| | benzoyl)pyrazole (WO 96/26206), |
| (1.1.1.42) | 1-ethyl-5-hydroxy-3-methyl-4-(2-chloro-4-methylsulfonyl-3-pyrazol-1-yl- |
| | benzoyl)pyrazole (WO 96/26206), |
| (1.1.1.43) | 1-ethyl-5-hydroxy-4-(2-chloro-4-methylsulfonyl-3-pyrazol-1-ylbenzoyl)- |
| | pyrazole (WO 96/26206), |
| (1.1.1.44) | (5-hydroxy-1-methyl-1H-pyrazol-4-yl)(3,3,4-trimethyl-1,1-dioxido-2,3- |
| | dihydro-1-benzothien-5-yl)methanone (US2002/0016262), |
| (1.1.1.45) | 1-methyl-4-[(3,3,4-trimethyl-1,1-dioxido-2,3-dihydro-1-benzothien-5- |
| | yl)carbonyl]-1H-pyrazol-5-ylpropane-1-sulfonate (US2002/0016262, |
| | WO 2002/015695); |
| (1.1.1.46) | benzobicyclon and |
| (1.1.1.47) | isoxachlortole, |
| (1.1.2) | inhibitors of carotenoid biosynthesis including phytoene desaturase |
| | inhibitors, such as, for example, |
| (1.1.2.1) | norflurazon, |
| (1.1.2.2) | beflubutamide, |
| (1.1.2.3) | fluridone, |
| (1.1.2.4) | flurochloridone, |
| (1.1.2.5) | flurtamone, |
| (1.1.2.6) | amitrole, |
| (1.1.2.7) | clomazone, |
| (1.1.2.8) | aclonifen, |
| (1.1.2.9) | diflufenican und |
| (1.1.2.10) | picolinafen, |
| (1.1.3) | inhibitors of dihydropteroate synthase (DHP synthase), such as, for |
| | example, |
| (1.1.3.1) | asulam, |
| (1.2) | herbicides which interfere with amino acid synthesis, such as, for |
| | example, |
| (1.2.1) | inhibitors of acetolactate synthase in plants, such as, for example, |
| (1.2.1.1) | 1-(2-chlorophenylsulfonyl)-3-(4-methoxy-6-methyl-1,3,5-triazin-2- |
| | yl)urea (chlorsulfuron), |
| (1.2.1.2) | 1-(2-ethoxycarbonylphenylsulfonyl)-3-(4-chloro-6-methoxypyrimidin-2- |
| | yl)urea (chlorimuron-ethyl), |
| (1.2.1.3) | 1-(2-methoxyphenylsulfonyl)-3-(4-methoxy-6-methyl-1,3,5-triazin-2- |
| | yl)urea (metsulfuron-methyl), |
| (1.2.1.4) | 1-(2-chloroethoxyphenylsulfonyl)-3-(4-methoxy-6-methyl-1,3,5-triazin-2- |
| | yl)urea (triasulfuron), |
| (1.2.1.5) | 1-(2-methoxycarbonylphenylsulfonyl)-3-(4,6-dimethylpyrimidin-2-yl)urea |
| | (sulfometuron-methyl), |
| (1.2.1.6) | 1-(2-methoxycarbonylphenylsulfonyl)-3-(4-methoxy-6-methyl-1,3,5- |
| | triazin-2-yl)-3-methylurea (tribenuron-methyl), |
| (1.2.1.7) | 1-(2-methoxycarbonylbenzylsulfonyl)-3-(4,6-dimethoxypyrimidin-2- |
| | yl)urea (bensulfuron-methyl), |
| (1.2.1.8) | 1-(2-methoxycarbonylphenylsulfonyl)-3-(4,6-bis-(difluoromethoxy)- |
| | pyrimidin-2-yl)urea (primisulfuron-methyl), |
| (1.2.1.9) | 3-(4-ethyl-6-methoxy-1,3,5-triazin-2-yl)-1-(2,3-dihydro-1,1-dioxo-2- |
| | methylbenzo-[b]thiophene-7-sulfonyl)urea (EP-A 0 079 683), |
| (1.2.1.10) | 3-(4-ethoxy-6-ethyl-1,3,5-triazin-2-yl)-1-(2,3-dihydro-1,1-dioxo-2- |
| | methylbenzo[b]-thiophene-7-sulfonyl)urea (EP-A 0 079 683), |
| (1.2.1.11) | 3-(4-methoxy-6-methyl-1,3,5-triazin-2-yl)-1-(2-methoxycarbonyl-5-iodo- |
| | phenylsulfonyl)urea (WO 92/13845), |
| (1.2.1.11a) | an agriculturally useful salt of the compound (1.2.1.11), |
| (1.2.1.11b) | the sodium salt of the compound (1.2.1.11), i.e. methyl 4-iodo-2-[3-(4- |
| | methoxy-6-methyl-1,3,5-triazin-2-yl)ureidosulfonyl]benzoate, sodium |
| | salt (iodosulfuron-methyl-sodium), |
| (1.2.1.12) | methyl 2-[4-dimethylamino-6-(2,2,2-trifluoroethoxy)-1,3,5-triazin-2- |
| | ylcarbamoylsulfamoyl]-3-methylbenzoate (DPX-66037, triflusulfuron- |
| | methyl), |
| (1.2.1.13) | oxetan-3-yl 2-[(4,6-dimethylpyrimidin-2-yl)-carbamoylsulfamoyl]- |
| | benzoate (CGA-277476, oxasulfuron), |
| (1.2.1.14) | methyl 2-[3-(4,6-dimethoxypyrimidin-2-yl)ureidosulfonyl]-4-methane- |
| | sulfonylaminomethylbenzoate (mesosulfuron-methyl, WO 95/10507), |
| (1.2.1.14a) | an agriculturally useful salt of the compound (1.2.1.14), |
| (1.2.1.14b) | the sodium salt of the compound (1.2.1.14), |
| (1.2.1.15) | N,N-dimethyl-2-[3-(4,6-dimethoxypyrimidin-2-yl)ureidosulfonyl]-4- |
| | formylaminobenzamide (foramsulfuron), WO 95/01344), |
| (1.2.1.15a) | an agriculturally useful salt of the compound (1.2.1.15), |
| (1.2.1.15b) | the sodium salt of the compound (1.2.1.15), |
| (1.2.1.16) | 1-(4,6-dimethoxy-1,3,5-triazin-2-yl)-3-[2-(2- |
| | methoxyethoxy)phenylsulfonyl]urea (cinosulfuron), |
| (1.2.1.17) | methyl 2-[(4-ethoxy-6-methylamino-1,3,5-triazin-2-yl)- |
| | carbamoylsulfamoyl]benzoate (ethametsulfuron-methyl), |
| (1.2.1.18) | 1-(4-methoxy-6-methyl-1,3,5-triazin-2-yl)-3-[2-(3,3,3-trifluoropropyl)- |
| | phenylsulfonyl]urea (prosulfuron), |
| (1.2.1.19) | methyl 2-(4,6-dimethylpyrimidin-2-ylcarbamoylsulfamoyl)benzoate |
| | (sulfometuron-methyl), |
| (1.2.1.20) | 1-(4-methoxy-6-trifluoromethyl-1,3,5-triazin-2-yl)-3-(2- |
| | trifluoromethylbenzenesulfonyl)urea (tritosulfuron), |
| (1.2.1.21) | N-[(4-methylpyrimidin-2-yl)carbamoyl]-2-nitrobenzenesulfonamide |
| | (monosulfuron), |
| (1.2.1.22) | methyl 2-[({[4-methoxy-6-(methylthio)pyrimidin-2-yl]carbamoyl}amino)- |
| | sulfonyl]benzoate, |
| (1.2.1.23) | 1-(2-methoxycarbonylthiophen-3-yl)-3-(4-methoxy-6-methyl-1,3,5- |
| | triazin-2-yl)urea (thifensulfuron-methyl), |
| (1.2.1.24) | 1-(4-ethoxycarbonyl-1-methylpyrazol-5-yl-sulfonyl)-3-(4,6- |
| | dimethoxypyrimidin-2-yl)urea (pyrazosulfuron-ethyl), |
| (1.2.1.25) | methyl 3-chloro-5-(4,6-dimethoxypyrimidin-2-ylcarbamoylsulfamoyl)-1- |
| | methylpyrazole-4-carboxylate (halosulfuron-methyl), |
| (1.2.1.26) | methyl 5-(4,6-dimethylpyrimidin-2-ylcarbamoylsulfamoyl)-1-(2-pyridyl)- |
| | pyrazole-4-carboxylate (NC-330, see Brighton Crop Prot. Conference |
| | ‘Weeds’ 1991, Vol. 1, p. 45 et seq.), |
| (1.2.1.27) | 1-(4,6-dimethoxypyrimidin-2-yl)-3-[1-methyl-4-(2-methyl-2H-tetrazol-5- |
| | yl)pyrazol-5-ylsulfonyl]urea (DPX-A8947, azimsulfuron), |
| (1.2.1.28) | N-[(4,6-dimethoxypyrimidin-2-yl)carbamoyl]-4-(5,5-dimethyl-4,5- |
| | dihydroisoxazol-3-yl)-1,3-dimethyl-1H-pyrazole-5-sulfonamide, |
| (1.2.1.29) | 3-(4,6-dimethoxypyrimidin-2-yl)-1-(N-methyl-N-methylsulfonylamino- |
| | sulfonyl) urea (amidosulfuron), |
| (1.2.1.29a) | an agriculturally useful salt of the compound (1.2.1.29), |
| (1.2.1.29b) | the sodium salt of the compound (1.2.1.29), |
| (1.2.1.29c) | structural analogs of amidosulfuron according to EP-A 0 131 258 and |
| | Z. Pfl. Krankh. Pfl. Schutz, special edition XII, 489-497 (1990), |
| (1.2.1.30) | 1-(3-N,N-dimethylaminocarbonylpyridin-2-ylsulfonyl)-3-(4,6- |
| | dimethoxypyrimidin-2-yl)urea (nicosulfuron), |
| (1.2.1.31) | 1-(3-ethylsulfonylpyridin-2-ylsulfonyl)-3-(4,6-dimethoxypyrimidin-2- |
| | yl)urea (rimsulfuron), |
| (1.2.1.32) | methyl 2-[3-(4,6-dimethoxypyrimidin-2-yl)ureidosulfonyl]-6- |
| | trifluoromethyl-3-pyridinecarboxylate, sodium salt (DPX-KE 459, |
| | flupyrsulfuron-methyl-sodium), |
| (1.2.1.33) | 3-(4,6-dimethoxypyrimidin-2-yl)-1-(3-N-methylsulfonyl-N-methyl- |
| | aminopyridin-2-yl)sulfonylurea (DE-A 40 00 503 and DE-A 40 30 577), |
| (1.2.1.33a) | an agriculturally useful salt of the compound (1.2.1.33), |
| (1.2.1.33b) | the sodium salt of the compound (1.2.1.33), |
| (1.2.1.34) | 1-(4,6-dimethoxypyrimidin-2-yl)-3-(3-trifluoromethyl-2-pyridylsulfonyl)- |
| | urea (flazasulfuron), |
| (1.2.1.35) | 1-(4,6-dimethoxypyrimidin-2-yl)-3-[3-(2,2,2-trifluoroethoxy)-2- |
| | pyridylsulfonyl]urea sodium salt (trifloxysulfuron-sodium), |
| (1.2.1.36) | (1RS,2RS;1RS,2SR)-1-{3-[(4,6-dimethoxypyrimidin-2-ylcarbamoyl)- |
| | sulfamoyl]-2-pyridyl}-2-fluoropropyl methoxyacetate (flucetosulfuron), |
| (1.2.1.37) | 3-(4,6-dimethoxypyrimidin-2-yl)-1-(2-ethoxyphenoxy)sulfonylurea |
| | (ethoxysulfuron), |
| (1.2.1.37a) | an agriculturally useful salt of the compound (1.2.1.37), |
| (1.2.1.37b) | the sodium salt of the compound (1.2.1.37), |
| (1.2.1.38) | 1-(4,6-dimethoxypyrimidin-2-yl)-3-(2-ethylsulfonylimidazo[1,2-a]pyridin- |
| | 3-yl)sulfonylurea (MON 37500, sulfosulfuron), |
| (1.2.1.39) | 1-(2-chloroimidazo[1,2-a]pyridin-3-ylsulfonyl)-3-(4,6- |
| | dimethoxypyrimidin-2-yl)urea (imazosulfuron), |
| (1.2.1.40) | 2-chloro-N-[(4,6-dimethoxypyrimidin-2-yl)carbamoyl]-6- |
| | propylimidazo[1,2-b]pyridazine-3-sulfonamide, |
| (1.2.1.41) | 1-[2-(cyclopropylcarbonyl)phenylaminosulfonyl]-3-(4,6- |
| | dimethoxypyrimidin-2-yl)urea (cyclosulfamuron), |
| (1.2.1.42) | 1-(4,6-dimethoxypyrimidin-2-yl)-3-[2- |
| | (dimethylcarbamoyl)phenylsulfamoyl]urea (orthosulfamuron), |
| (1.2.1.43) | imazamethabenz-methyl, |
| (1.2.1.44) | imazapic, |
| (1.2.1.45) | imazamox, |
| (1.2.1.46) | imazapyr, |
| (1.2.1.47) | imazaquin and |
| (1.2.1.48) | imazethapyr; |
| (1.2.1.49) | chloransulam-methyl, |
| (1.2.1.50) | diclosulam, |
| (1.2.1.51) | florasulam, |
| (1.2.1.52) | flumetsulam, |
| (1.2.1.53) | metosulam, |
| (1.2.1.54) | penoxsulam, |
| (1.2.1.55) | pyroxsulam; |
| (1.2.1.56) | 4,5-dihydro-3-methoxy-4-methyl-5-oxo-N-(2- |
| | trifluoromethoxyphenylsulfonyl)-1H-1,2,4-triazole-1-carboxamide |
| (1.2.1.56a) | an agriculturally useful salt of the compound (1.2.1.56), |
| (1.2.1.56b) | the sodium salt of the compound (1.2.1.56), i.e. flucarbazone-sodium, |
| (1.2.1.57) | methyl 2-(4,5-dihydro-4-methyl-5-oxo-3-propoxy-1H-1,2,4-triazol-1-yl)- |
| | carboxamidosulfonylbenzoate |
| (1.2.1.57a) | an agriculturally useful salt of the compound (1.2.1.57), |
| (1.2.1.57b) | the sodium salt of the compound (1.2.1.57), i.e. propoxycarbazone- |
| | sodium, |
| (1.2.1.58) | methyl 4-[(4,5-dihydro-3-methoxy-4-methyl-5-oxo-1H-1,2,4-triazol-1- |
| | yl)carbonylsulfamoyl]-5-methylthiophene-3-carboxylate |
| | (thiencarbazone-methyl); |
| (1.2.1.59) | benzyl 3-(4,6-dimethoxypyrimidin-2-yl)oxypyridine-2-carboxylate (EP-A |
| | 0 249 707), |
| (1.2.1.60) | methyl 3-(4,6-dimethoxypyrimidin-2-yl)-oxypyridine-2-carboxylate (EP-A |
| | 0 249 707), |
| (1.2.1.61) | 1-(ethoxycarbonyloxyethyl) 2,6-bis[(4,6-dimethoxypyrimidin-2-yl)oxy]- |
| | benzoate (EP-A 0 472 113), |
| (1.2.1.62) | 2,6-bis[(4,6-dimethoxypyrimidin-2-yl)oxy]benzoic acid |
| (1.2.1.62a) | an agriculturally useful salt of the compound (1.2.1.62), |
| (1.2.1.62b) | the sodium salt of the compound (1.2.1.62), i.e. bispyribac-sodium, |
| (1.2.1.63) | isopropyl 4-[[[2-[(4,6-dimethoxy-2-pyrimidinyl)oxy]phenyl]methyl]amino]- |
| | benzoate (pyribambenz-isopropyl, WO 2002034724), |
| (1.2.1.64) | propyl 4-[[[2-[(4,6-dimethoxy-2-pyrimidinyl)oxy]phenyl]methyl]amino]- |
| | benzoate (pyribambenz-propyl, WO 2002034724), |
| (1.2.1.65) | pyribenzoxim, |
| (1.2.1.66) | pyriftalid, |
| (1.2.1.67) | pyriminobac-methyl, |
| (1.2.1.68) | 2-chloro-6-(4,6-dimethoxypyrimidin-2-ylthio)benzoic acid, |
| (1.2.1.68a) | an agriculturally useful salt of the compound (1.2.1.68), |
| (1.2.1.68b) | the sodium salt of the compound (1.2.1.62), i.e. pyrithiobac-sodium, |
| | and |
| (1.2.1.69) | pyrimisulfan; |
| (1.2.2) | inhibitors of EPSP synthase, such as, for example, |
| (1.2.2.1) | N-(phosphonomethyl)glycine (glyphosate), |
| (1.2.2.1a) | an agriculturally useful salt of the compound (1.2.2.1), |
| (1.2.1.1b) | the sodium salt of the compound (1.2.2.1), (glyphosate-sodium) |
| (1.2.1.1c) | the isopropylammonium salt of the compound (1.2.2.1), (glyphosate- |
| | isopropylammonium) |
| (1.2.2.2) | N-(phosphonomethyl)glycine trimesium salt (sulfosate); |
| (1.2.3) | inhibitors of glutamine synthetase, such as, for example, |
| (1.2.3.1) | 4-[hydroxy(methyl)phosphinoyl]-L-homoalanyl-L-alanyl-L-alanine |
| | (bialaphos = bilanafos), |
| (1.2.3.2) | DL-homoalanin-4-yl(methyl)phosphinic acid (glufosinate) |
| (1.2.3.1a) | an agriculturally useful salt of the compound (1.2.3.1), |
| (1.2.3.1b) | the sodium salt of the compound (1.2.2.1), |
| (1.2.3.1c) | the ammonium salt of the compound (1.2.3.1), (glufosinate-ammonium) |
| (1.3) | inhibitors of lipid synthesis in plants, such as, for example, |
| (1.3.1) | inhibitors of acetyl-coenzyme A carboxylase (ACCase), for example |
| (1.3.1.1) | methyl 2-(4-(2,4-dichlorophenoxy)phenoxy)propionate (diclofop- |
| | methyl), |
| (1.3.1.1a) | methyl (R)-2-(4-(2,4-dichlorophenoxy)phenoxy)propionate (diclofop-P- |
| | methyl), |
| (1.3.1.2) | methyl 2-(4-(4-bromo-2-chlorophenoxy)phenoxy)propionate (DE-A |
| | 26 01 548), |
| (1.3.1.3) | methyl 2-(4-(4-bromo-2-fluorophenoxy)phenoxy)propionate (US-A |
| | 4,808,750), |
| (1.3.1.4) | methyl 2-(4-(2-chloro-4-trifluoromethylphenoxy)phenoxy)propionate |
| | (DE-A 24 33 067), |
| (1.3.1.5) | methyl 2-(4-(2-fluoro-4-trifluoromethylphenoxy)phenoxy)propionate |
| | (US-A 4,808,750), |
| (1.3.1.6) | methyl 2-(4-(2,4-dichlorobenzyl)phenoxy)propionate (DE-A 24 17 487), |
| (1.3.1.7) | ethyl 4-(4-(4-trifluoromethylphenoxy)phenoxy)pent-2-enoate, |
| (1.3.1.8) | methyl 2-(4-(4-trifluoromethylphenoxy)phenoxy)propionate |
| | (DE-A 24 33 067); |
| (1.3.1.9) | butyl (R)-2-[4-(4-cyano-2-fluorophenoxy)phenoxy]propionate |
| | (cyhalofop-butyl) |
| (1.3.1.10) | ethyl 2-(4-(3,5-dichloropyridyl-2-oxy)phenoxy)propionate |
| | (EP-A 0 002 925), |
| (1.3.1.11) | propargyl 2-(4-(3,5-dichloropyridyl-2-oxy)phenoxy)propionate (EP-A |
| | 0 003 114), |
| (1.3.1.12) | (RS)-2-(4-(3-chloro-5-trifluoromethyl-2-pyridyloxy)phenoxy)propionic |
| | acid (Haloxyfop), |
| (1.3.1.12a) | methyl ester of (1.3.1.12), i.e. (haloxyfop-methyl), |
| (1.3.1.12b) | etotyl ester (= ethoxyethyl ester) of (1.3.1.12), i.e. (haloxyfop-etotyl), |
| (1.3.1.12c) | sodium salt of (1.3.1.12), i.e. (haloxyfop-Na), |
| (1.3.1.12d) | (R)-2-(4-(3-chloro-5-trifluoromethyl-2-pyridyloxy)phenoxy)propionic acid |
| | (haloxyfop-P), |
| (1.3.1.12e) | methyl ester of (1.3.1.12d), i.e. (haloxyfop-P-methyl) |
| (1.3.1.12f) | etotyl ester (= ethoxyethyl ester) of (1.3.1.12d), i.e. (haloxyfop-P-etotyl), |
| (1.3.1.12g) | sodium salt of (1.3.1.12d), i.e. (haloxyfop-P-Na), |
| (1.3.1.13) | ethyl 2-(4-(3-chloro-5-trifluoromethyl-2-pyridyloxy)phenoxy)propionate |
| | (EP-A 0 003 890), |
| (1.3.1.14) | propargyl 2-(4-(5-chloro-3-fluoro-2-pyridyloxy)phenoxy)propionate |
| | (clodinafop-propargyl), |
| (1.3.1.15) | butyl (RS)-2-(4-(5-trifluoromethyl-2-pyridyloxy)phenoxy)propionate |
| | (fluazifop-butyl), |
| (1.3.1.15a) | butyl (R)-2-(4-(5-trifluoromethyl-2-pyridyloxy)phenoxy)propionate |
| | (fluazifop-P-butyl); |
| (1.3.1.16) | (R)-2-[4-(3-chloro-5-trifluoromethyl-2-pyridyloxy)phenoxy]propionic |
| | acid, |
| (1.3.1.17) | (RS)-2-(4-(6-chloro-2-quinoxalyloxy)phenoxy)propionic acid, |
| | (quizalofop), |
| (1.3.1.17a) | (R)-2-(4-(6-chloro-2-quinoxalyloxy)phenoxy)propionc acid |
| | (quizalofop-P), |
| (1.3.1.17b) | ethyl ester of (1.3.1.17) (quizalofop-ethyl), |
| (1.3.1.17c) | methyl ester of (1.3.1.17) (quizalofop-methyl), |
| (1.3.1.17d) | tetrahydrofurfuryl ester of (1.3.1.17) (quizalofop-tefuryl), |
| (1.3.1.17e) | ethyl ester of (1.3.1.17a) (quizalofop-P-ethyl), |
| (1.3.1.17f) | methyl ester of (1.3.1.17a) (quizalofop-P-methyl), |
| (1.3.1.17g) | tetrahydrofurfuryl ester of (1.3.1.17a) (quizalofop-P-tefuryl), |
| (1.3.1.18) | 2-isopropylideneaminooxyethyl (R)-2-(4-(6-chloro-2- |
| | quinoxalyloxy)phenoxy)propionate (propaquizafop), |
| (1.3.1.19) | methyl 2-(4-(6-fluoro-2quinoxalyloxy)phenoxy)propionate (see J. Pest. |
| | Sci. Vol. 10, 61 (1985)), |
| (1.3.1.20) | (RS)-2-(4-(6-chlorobenzoxazol-2-yloxy)phenoxy)propionic acid |
| | (fenoxaprop), |
| (1.3.1.20a) | ethyl ester of (1.3.1.20), i.e. fenoxaprop-ethyl, |
| (1.3.1.20b) | (R)-2-(4-(6-chlorobenzoxazol-2-yl-oxy)phenoxy)propionic acid |
| | (fenoxaprop-P), |
| (1.3.1.20c) | ethyl ester of (1.3.1.20b), i.e. fenoxaprop-P-ethyl, |
| (1.3.1.21) | ethyl 2-(4-(6-chlorobenzothiazol-2-yloxy)phenoxy)propionate (DE-A- |
| | 26 40 730), |
| (1.3.1.22) | (R)-2-[4-(6-chloro-1,3-benzoxazol-2-yloxy)phenoxy]-2′-fluoro-N- |
| | methylpropionanilide (metamifop), |
| (1.3.1.23) | alloxydim, |
| (1.3.1.24) | butroxydim, |
| (1.3.1.25) | clethodim, |
| (1.3.1.26) | cloproxydim, |
| (1.3.1.27) | cycloxydim, |
| (1.3.1.28) | profoxydim, |
| (1.3.1.29) | sethoxydim, |
| (1.3.1.30) | tepraloxydim, |
| (1.3.1.31) | tralkoxydim and |
| (1.3.1.32) | 8-(2,6-diethyl-p-tolyl)-1,2,4,5-tetrahydro-7-oxo-7H-pyrazolo[1,2- |
| | d][1,4,5]oxadiazepin-9-yl 2,2-dimethylpropionate (pinoxaden). |
| (1.3.2) | inhibitors of lipid synthesis having a mechanism of action different from |
| | that of ACCase inhibitors, for example |
| (1.3.2.1) | S-ethyl N,N-dipropylthiocarbamate (EPTC), |
| (1.3.2.2) | S-ethyl N,N-diisobutylthiocarbamate (butylate), |
| (1.3.2.3) | thiobencarb = benthiocarb, |
| (1.3.2.4) | cycloate, |
| (1.3.2.5) | dimepiperate, |
| (1.3.2.6) | esprocarb, |
| (1.3.2.7) | molinate, |
| (1.3.2.8) | orbencarb, |
| (1.3.2.9) | pebulate, |
| (1.3.2.10) | prosulfocarb, |
| (1.3.2.11) | tiocarbazil and |
| (1.3.2.12) | tri-allate; |
| (1.3.2.13) | vernolate, |
| (1.3.2.14) | bensulide, |
| (1.3.2.15) | benfuresate, |
| (1.3.2.16) | ethofumesate, |
| (1.3.2.17) | TCA, |
| (1.3.2.18) | dalapon and |
| (1.3.2.19) | flupropanate, |
| (1.4) | inhibitors of cell division and cell development, for example |
| (1.4.1) | inhibitors of cell wall synthesis (cellulose synthesis inhibitors), for |
| | example |
| (1.4.1.1) | dichlobenil, |
| (1.4.1.2) | chlorthiamid, |
| (1.4.1.3) | isoxaben, |
| (1.4.1.4) | flupoxam and |
| (1.4.1.5) | triaziflam, |
| (1.4.2) | inhibitors of microtubuli (inhibitors of the formation of microtubuli and |
| | their organisation), such as |
| (1.4.2.1) | benefin = benfluralin, |
| (1.4.2.2) | butralin, |
| (1.4.2.3) | dinitramine, |
| (1.4.2.4) | ethalfluralin, |
| (1.4.2.5) | oryzalin, |
| (1.4.2.6) | pendimethalin, |
| (1.4.2.7) | trifluralin, |
| (1.4.2.8) | amiprophos-methyl, |
| (1.4.2.9) | butamiphos, |
| (1.4.2.10) | propyzamide = pronamide, |
| (1.4.2.11) | tebutam, |
| (1.4.2.12) | DCPA = chlorthal-dimethyl, |
| (1.4.2.13) | chlorpropham, |
| (1.4.2.14) | propham, |
| (1.4.2.15) | carbetamide, |
| (1.4.2.16) | dithiopyr and |
| (1.4.2.17) | thiazopyr, |
| (1.4.3) | inhibitors of mitosis or microtubuli organisation, such as |
| (1.4.3.1) | chlorpropham, |
| (1.4.3.2) | propham, |
| (1.4.3.3) | carbetamide, |
| (1.4.4) | inhibitors of the synthesis of very long-chain fatty acids (VLCFAs), such |
| | as |
| (1.4.4.1) | acetochlor, |
| (1.4.4.2) | alachlor, |
| (1.4.4.3) | butachlor, |
| (1.4.4.4) | dimethachlor, |
| (1.4.4.5) | dimethenamid, |
| (1.4.4.6) | metazachlor, |
| (1.4.4.7) | metolachlor, |
| (1.4.4.8) | S-metolachlor, |
| (1.4.4.9) | pethoxamid, |
| (1.4.4.10) | pretilachlor, |
| (1.4.4.11) | propachlor, |
| (1.4.4.12) | propisochlor and |
| (1.4.4.13) | thenylchlor, |
| (1.4.4.14) | diphenamid, |
| (1.4.4.15) | napropamide, |
| (1.4.4.16) | naproanilide, |
| (1.4.4.17) | flufenacet, |
| (1.4.4.18) | mefenacet, |
| (1.4.4.19) | fentrazamide, |
| (1.4.4.20) | cafenstrole, |
| (1.4.4.21) | piperophos, |
| (1.4.4.22) | S-(N-aryl-N-alkylcarbamoylmethyl)dithiophosphonates and |
| (1.4.4.22a) | S-[N-(4-chlorophenyl)-N-isopropylcarbamoylmethyl] O,O-dimethyl |
| | dithiophosphate (anilofos), |
| (1.5) | herbicides which disrupt photosynthesis, such as |
| (1.5.1) | inhibitors of the photosynthesis II system, such as |
| (1.5.1.1) | desmetryne, |
| (1.5.1.2) | bromacil, |
| (1.5.1.3) | lenacil, |
| (1.5.1.4) | terbacil, |
| (1.5.1.5) | pyrazon = chloridazon, |
| (1.5.1.6) | desmedipham, |
| (1.5.1.7) | phenmedipham, |
| (1.5.1.8) | chlorobromuron, |
| (1.5.1.9) | chlorotoluron, |
| (1.5.1.10) | chloroxuron, |
| (1.5.1.11) | dimefuron, |
| (1.5.1.12) | diuron, |
| (1.5.1.13) | ethidimuron, |
| (1.5.1.14) | fenuron, |
| (1.5.1.15) | fluometuron, |
| (1.5.1.16) | isoproturon, |
| (1.5.1.17) | isouron, |
| (1.5.1.18) | linuron, |
| (1.5.1.19) | methabenzthiazuron, |
| (1.5.1.20) | metobromuron, |
| (1.5.1.21) | metoxuron, |
| (1.5.1.22) | monolinuron, |
| (1.5.1.23) | neburon, |
| (1.5.1.24) | siduron, |
| (1.5.1.25) | tebuthiuron, |
| (1.5.1.26) | propanil, |
| (1.5.1.27) | pentanochlor, |
| (1.5.1.28) | bromofenoxim, |
| (1.5.1.29) | bromoxynil, |
| (1.5.1.30) | ioxynil, |
| (1.5.1.31) | bentazone, |
| (1.5.1.32) | pyridate, |
| (1.5.1.33) | pyridafol, |
| (1.5.1.34) | 4-amino-N-tert-butyl-4,5-dihydro-3-isopropyl-5-oxo-1,2,4-1H-triazole-1- |
| | carboxamide (amicarbazone), |
| (1.5.1.35) | 3-cyclohexyl-6-dimethylamino-1-methyl-1,3,5-triazine-2,4-(1H,3H)- |
| | dione (hexazinone), |
| (1.5.1.36) | 4-amino-4,5-dihydro-3-methyl-6-phenyl-1,2,4-triazin-5-one |
| | (metamitron), |
| (1.5.1.37) | 4-amino-6-tert-butyl-4,5-dihydro-3-methylthio-1,2,4-triazin-5-one |
| | (metribuzin); |
| (1.5.1.38) | ametryn, |
| (1.5.1.39) | atrazine, |
| (1.5.1.40) | cyanazine, |
| (1.5.1.41) | dimethametrin, |
| (1.5.1.42) | prometon, |
| (1.5.1.43) | prometryn, |
| (1.5.1.44) | propazine, |
| (1.5.1.45) | simazine, |
| (1.5.1.46) | symetryn, |
| (1.5.1.47) | terbumeton, |
| (1.5.1.48) | terbuthylazine, |
| (1.5.1.49) | terbutryn and |
| (1.5.1.50) | trietazine, |
| (1.6) | herbicides which adversely affect plant development by hormone-like |
| | effects, such as |
| (1.6.1) | clomeprop, |
| (1.6.2) | 2,4-D, |
| (1.6.3) | 2,4-DB, |
| (1.6.4) | dichlorprop = 2,4-DP, |
| (1.6.5) | MCPA, |
| (1.6.6) | MCPB, |
| (1.6.7) | mecoprop = MCPP = CMPP, |
| (1.6.8) | chloramben, |
| (1.6.9) | dicamba, |
| (1.6.10) | TBA, |
| (1.6.11) | quinclorac, |
| (1.6.12) | quinmerac, |
| (1.6.13) | benazolin-ethyl, |
| (1.6.14) | naptalam, |
| (1.6.15) | diflufenzopyr-Na, |
| (1.6.16) | aminopyralid, |
| (1.6.17) | clopyralid, |
| (1.6.18) | fluroxypyr, |
| (1.6.19) | picloram, |
| (1.6.20) | triclopyr, |
| (1.6.21) | forchlorfenuron and |
| (1.6.22) | thidiazuron; |
| (1.7) | herbicides having an as yet unconfirmed mechanism of action, such as |
| (1.7.1) | flamprop-M-methyl/-isopropyl, |
| (1.7.2) | difenzoquat, |
| (1.7.3) | DSMA, |
| (1.7.4) | MSMA, |
| (1.7.5) | bromobutide, |
| (1.7.6) | (chloro)-flurenol, |
| (1.7.7) | cinmethylin, |
| (1.7.8) | cumyluron, |
| (1.7.9) | dazomet, |
| (1.7.10) | dymron = daimuron, |
| (1.7.11) | methyl-dimuron = methyl-dymron, |
| (1.7.12) | etobenzanid, |
| (1.7.13) | fosamine, |
| (1.7.14) | indanofan, |
| (1.7.15) | metam, |
| (1.7.16) | oxaziclomefone and |
| (1.7.17) | pyributicarb, |
| (2) | herbicides having a rapid onset of harmful action, for example |
| (2.1) | herbicides which negatively affect the electron transport in the photo |
| | system I, such as |
| (2.1.1) | 1,1′-ethylene-2,2′-bipyridyldiylium salts (diquat), |
| (2.1.1a) | the dibromide of (2.1.1) (diquat dibromide), |
| (2.1.2) | 1,1′-dimethyl-4,4′-bipyridinium salts (paraquat), |
| (2.1.2a) | the dichloride of (2.1.2) (paraquat dichloride), |
| (2.2) | inhibitors of protoporphyrin oxidase, such as |
| (2.2.1) | acifluorfen-Na, |
| (2.2.2) | bifenox, |
| (2.2.3) | chlomethoxyfen, |
| (2.2.4) | fluoroglycofen-ethyl, |
| (2.2.5) | fomesafen, |
| (2.2.6) | halosafen, |
| (2.2.7) | lactofen, |
| (2.2.8) | oxyfluorfen, |
| (2.2.9) | fluazolate, |
| (2.2.10) | pyraflufen-ethyl, |
| (2.2.11) | cinidon-ethyl, |
| (2.2.12) | flumioxazin, |
| (2.2.13) | flumiclorac-pentyl, |
| (2.2.14) | fluthiacet-methyl, |
| (2.2.15) | thidiazimin, |
| (2.2.16) | oxadiazon, |
| (2.2.17) | oxadiargyl, |
| (2.2.18) | pentoxazone, |
| (2.2.19) | benzfendizone, |
| (2.2.20) | butafenacil, |
| (2.2.21) | pyraclonil, |
| (2.2.22) | profluazol, |
| (2.2.23) | flufenpyr-ethyl, |
| (2.2.24) | 2-(2,4-dichloro-5-prop-2-ynyloxyphenyl)-5,6,7,8-tetrahydro-1,2,4- |
| | triazolo[4,3-a]pyridin-3(2H)-one (azafenidin), |
| (2.2.25) | ethyl (RS)-2-chloro-3-[2-chloro-5-(4-difluoromethyl-4,5-dihydro-3- |
| | methyl-5-oxo-1H-1,2,4-triazol-1-yl)-4-fluorophenyl]propionate |
| | (carfentrazone-ethyl), |
| (2.2.26) | 2′,4′-dichloro-5′-(4-difluoromethyl-4,5-dihydro-3-methyl-5-oxo-1H-1,2,4- |
| | triazol-1-yl)-methanesulfonanilide (sulfentrazone) and |
| (2.2.27) | 4-[4,5-dihydro-4-methyl-5-oxo-3-(trifluoromethyl)-1H-1,2,4-triazol-1-yl]- |
| | 2-[(ethylsulfonyl)amino]-5-fluorobenzenecarbothioamide |
| | (bencarbazone); |
| (2.3) | destroyers of the cell membranes in plants, such as |
| (2.3.1) | DNOC, |
| (2.3.2) | dinoseb and |
| (2.3.3) | dinoterb, |
| (2.4) | herbicides having an unknown mechanism of action, such as |
| (2.4.1) | oleic acid and |
| (2.4.2) | pelargonic acid. |

The abovementioned herbicides of groups (1) and (2) (see Table 3) and their subgroups are known from the respective abovementioned publications and defined by their chemical name or, in the case of commercial products, by the common names given, for example, in “The Pesticide Manual”, The British Crop Protection Council, 14th edition, 2006, or in the corresponding e-Pesticide Manual, version 4.0, British Crop Protection Council 2006 or else in the “Compendium of Pesticide Common Names” (available via the internet).

If the commercial active compounds are preferably present in the form of a special salt or ester of the stated compound, the reference to the compound preferably also includes the customary commercial form, if this has not likewise been stated.

In some cases, the herbicide groups (1) and (2) and their subgroups comprise active compounds from various structural classes. The respective herbicides from the same structural class of a group or subgroup of the groups (1) and (2) mentioned thus form in each case a more preferred subgroup within the respective mechanism-of-action or phenomenological group.

The active compounds mentioned above are suitable for the use according to the invention in combination with safeners (I) or their salts, preferably in combination with compounds of the formula (Ia), (Ib) or (Ic) or their salts.

Preference is given to the use according to the invention with crop protection compositions comprising a combination of a compound (Ia), (Ib) or (Ic) with one or more active compounds from the group of the herbicide groups (1), (1.1), (1.1.1), (1.1.2), (1.1.3), (1.2), (1.2.1), (1.2.2), (1.3), (1.3.1), (1.3.2), (1.4), (1.4.1), (1.4.2), (1.4.3), (1.4.4), (1.5), (1.5.1), (1.6), (1.7), (2), (2.1), (2.2), (2.3) and (2.4).

More preference is given to the use according to the invention with crop protection compositions comprising a combination of a compound (Ia), (Ib) or (Ic) with one or more active compounds from the abovementioned herbicide group (1), (1.1), (1.1.1), (1.1.2), (1.1.3), (1.2), (1.2.1), (1.2.2), (1.3), (1.3.1), (1.3.2), (1.4), (1.4.1), (1.4.2), (1.4.3), (1.4.4), (1.5), (1.5.1), (1.6), (1.7), (2), (2.1), (2.2), (2.3) or (2.4).

Particular preference is given to the use according to the invention with crop protection compositions comprising a safener/herbicide combination of Table 4 below:

TABLE 4
Specific herbicide/safener combinatons

(Ia) + (1.1.1.1), (Ia) + (1.1.1.2), (Ia) + (1.1.1.3), (Ia) + (1.1.1.4), (Ia) + (1.1.1.5),
(Ia) + (1.1.1.6), (Ia) + (1.1.1.7), (Ia) + (1.1.1.8), (Ia) + (1.1.1.9), (Ia) + (1.1.1.10),
(Ia) + (1.1.1.11), (Ia) + (1.1.1.12), (Ia) + (1.1.1.13), (Ia) + (1.1.1.14), (Ia) + (1.1.1.15),
(Ia) + (1.1.1.16), (Ia) + (1.1.1.17), (Ia) + (1.1.1.18), (Ia) + (1.1.1.19), (Ia) + (1.1.1.20),
(Ia) + (1.1.1.21), (Ia) + (1.1.1.22), (Ia) + (1.1.1.23), (Ia) + (1.1.1.24), (Ia) + (1.1.1.25),
(Ia) + (1.1.1.26), (Ia) + (1.1.1.27), (Ia) + (1.1.1.28), (Ia) + (1.1.1.29), (Ia) + (1.1.1.30),
(Ia) + (1.1.1.31), (Ia) + (1.1.1.32), (Ia) + (1.1.1.33), (Ia) + (1.1.1.34), (Ia) + (1.1.1.35),
(Ia) + (1.1.1.36), (Ia) + (1.1.1.37), (Ia) + (1.1.1.38), (Ia) + (1.1.1.39), (Ia) + (1.1.1.40),
(Ia) + (1.1.1.41), (Ia) + (1.1.1.42), (Ia) + (1.1.1.43), (Ia) + (1.1.1.44), (Ia) + (1.1.1.45),
(Ia) + (1.1.1.46), (Ia) + (1.1.1.47), (Ia) + (1.1.2.1), (Ia) + (1.1.2.2), (Ia) + (1.1.2.3),
(Ia) + (1.1.2.4), (Ia) + (1.1.2.5), (Ia) + (1.1.2.6), (Ia) + (1.1.2.7), (Ia) + (1.1.2.8),
(Ia) + (1.1.2.9), (Ia) + (1.1.2.10), (Ia) + (1.1.3.1), (Ia) + (1.2.1.1), (Ia) + (1.2.1.2),
(Ia) + (1.2.1.3), (Ia) + (1.2.1.4), (Ia) + (1.2.1.5), (Ia) + (1.2.1.6), (Ia) + (1.2.1.7),
(Ia) + (1.2.1.8), (Ia) + (1.2.1.9), (Ia) + (1.2.1.10), (Ia) + (1.2.1.11), (Ia) + (1.2.1.11a),
(Ia) + (1.2.1.11b), (Ia) + (1.2.1.12), (Ia) + (1.2.1.13), (Ia) + (1.2.1.14),
(Ia) + (1.2.1.14a), (Ia) + (1.2.1.14b), (Ia) + (1.2.1.15), (Ia) + (1.2.1.15a),
(Ia) + (1.2.1.15b), (Ia) + (1.2.1.16), (Ia) + (1.2.1.17), (Ia) + (1.2.1.18),
(Ia) + (1.2.1.19), (Ia) + (1.2.1.20), (Ia) + (1.2.1.21), (Ia) + (1.2.1.22),
(Ia) + (1.2.1.23), (Ia) + (1.2.1.24), (Ia) + (1.2.1.25), (Ia) + (1.2.1.26),
(Ia) + (1.2.1.27), (Ia) + (1.2.1.28), (Ia) + (1.2.1.29), (Ia) + (1.2.1.29a),
(Ia) + (1.2.1.29b), (Ia) + (1.2.1.29c), (Ia) + (1.2.1.30), (Ia) + (1.2.1.31),
(Ia) + (1.2.1.32), (Ia) + (1.2.1.33), (Ia) + (1.2.1.33a), (Ia) + (1.2.1.34),
(Ia) + (1.2.1.35), (Ia) + (1.2.1.36), (Ia) + (1.2.1.37), (Ia) + (1.2.1.37a),
(Ia) + (1.2.1.37b), (Ia) + (1.2.1.38), (Ia) + (1.2.1.39), (Ia) + (1.2.1.40),
(Ia) + (1.2.1.41), (Ia) + (1.2.1.42), (Ia) + (1.2.1.43), (Ia) + (1.2.1.44),
(Ia) + (1.2.1.45), (Ia) + (1.2.1.46), (Ia) + (1.2.1.47), (Ia) + (1.2.1.48),
(Ia) + (1.2.1.49), (Ia) + (1.2.1.50), (Ia) + (1.2.1.51), (Ia) + (1.2.1.52),
(Ia) + (1.2.1.53), (Ia) + (1.2.1.54), (Ia) + (1.2.1.55), (Ia) + (1.2.1.56),
(Ia) + (1.2.1.56a), (Ia) + (1.2.1.56b), (Ia) + (1.2.1.57), (Ia) + (1.2.1.57a),
(Ia) + (1.2.1.57b), (Ia) + (1.2.1.58), (Ia) + (1.2.1.59), (Ia) + (1.2.1.60),
(Ia) + (1.2.1.61), (Ia) + (1.2.1.62), (Ia) + (1.2.1.62a), (Ia) + (1.2.1.62b),
(Ia) + (1.2.1.63), (Ia) + (1.2.1.64), (Ia) + (1.2.1.65), (Ia) + (1.2.1.66),
(Ia) + (1.2.1.67), (Ia) + (1.2.1.68), (Ia) + (1.2.1.68a), (Ia) + (1.2.1.68b),
(Ia) + (1.2.1.69), (Ia) + (1.2.2.1), (Ia) + (1.2.2.1a), (Ia) + (1.2.1.1b),
(Ia) + (1.2.1.1c), (Ia) + (1.2.2.2), (Ia) + (1.2.3), (Ia) + (1.2.3.1),
(Ia) + (1.2.3.2), (Ia) + (1.2.3.1a), (Ia) + (1.2.3.1b), (Ia) + (1.2.3.1c),
(Ia) + (1.3.1.1), (Ia) + (1.3.1.1a), (Ia) + (1.3.1.2), (Ia) + (1.3.1.3),
(Ia) + (1.3.1.4), (Ia) + (1.3.1.5), (Ia) + (1.3.1.6), (Ia) + (1.3.1.7),
(Ia) + (1.3.1.8), (Ia) + (1.3.1.9), (Ia) + (1.3.1.10), (Ia) + (1.3.1.11),
(Ia) + (1.3.1.12), (Ia) + (1.3.1.12a), (Ia) + (1.3.1.12b), (Ia) + (1.3.1.12c),
(Ia) + (1.3.1.12d), (Ia) + (1.3.1.12e), (Ia) + (1.3.1.12f), (Ia) + (1.3.1.12g),
(Ia) + (1.3.1.13), (Ia) + (1.3.1.14), (Ia) + (1.3.1.15), (Ia) + (1.3.1.15a),
(Ia) + (1.3.1.16), (Ia) + (1.3.1.17), (Ia) + (1.3.1.17a), (Ia) + (1.3.1.17b),
(Ia) + (1.3.1.17c), (Ia) + (1.3.1.17d), (Ia) + (1.3.1.17e), (Ia) + (1.3.1.17f),
(Ia) + (1.3.1.17g), (Ia) + (1.3.1.18), (Ia) + (1.3.1.19), (Ia) + (1.3.1.20),
(Ia) + (1.3.1.20a), (Ia) + (1.3.1.20b), (Ia) + (1.3.1.20c), (Ia) + (1.3.1.21),
(Ia) + (1.3.1.22), (Ia) + (1.3.1.23), (Ia) + (1.3.1.24), (Ia) + (1.3.1.25),
(Ia) + (1.3.1.26), (Ia) + (1.3.1.27), (Ia) + (1.3.1.28), (Ia) + (1.3.1.29),
(Ia) + (1.3.1.30), (Ia) + (1.3.1.31), (Ia) + (1.3.1.32), (Ia) + (1.3.2.1),
(Ia) + (1.3.2.2), (Ia) + (1.3.2.3), (Ia) + (1.3.2.4), (Ia) + (1.3.2.5),
(Ia) + (1.3.2.6), (Ia) + (1.3.2.7), (Ia) + (1.3.2.8), (Ia) + (1.3.2.9),
(Ia) + (1.3.2.10), (Ia) + (1.3.2.11), (Ia) + (1.3.2.12), (Ia) + (1.3.2.13),
(Ia) + (1.3.2.14), (Ia) + (1.3.2.15), (Ia) + (1.3.2.16), (Ia) + (1.3.2.17),
(Ia) + (1.3.2.18), (Ia) + (1.3.2.19), (Ia) + (1.4.1.1), (Ia) + (1.4.1.2),
(Ia) + (1.4.1.3), (Ia) + (1.4.1.4), (Ia) + (1.4.1.5), (Ia) + (1.4.2.1),
(Ia) + (1.4.2.2), (Ia) + (1.4.2.3), (Ia) + (1.4.2.4), (Ia) + (1.4.2.5),
(Ia) + (1.4.2.6), (Ia) + (1.4.2.7), (Ia) + (1.4.2.8), (Ia) + (1.4.2.9),
(Ia) + (1.4.2.10), (Ia) + (1.4.2.11), (Ia) + (1.4.2.12), (Ia) + (1.4.2.13),
(Ia) + (1.4.2.14), (Ia) + (1.4.2.15), (Ia) + (1.4.2.16), (Ia) + (1.4.2.17),
(Ia) + (1.4.3.1), (Ia) + (1.4.3.2), (Ia) + (1.4.3.3), (Ia) + (1.4.4.1),
(Ia) + (1.4.4.2), (Ia) + (1.4.4.3), (Ia) + (1.4.4.4), (Ia) + (1.4.4.5),
(Ia) + (1.4.4.6), (Ia) + (1.4.4.7), (Ia) + (1.4.4.8), (Ia) + (1.4.4.9),
(Ia) + (1.4.4.10), (Ia) + (1.4.4.11), (Ia) + (1.4.4.12), (Ia) + (1.4.4.13),
(Ia) + (1.4.4.14), (Ia) + (1.4.4.15), (Ia) + (1.4.4.16), (Ia) + (1.4.4.17),
(Ia) + (1.4.4.18), (Ia) + (1.4.4.19), (Ia) + (1.4.4.20), (Ia) + (1.4.4.21),
(Ia) + (1.4.4.22), (Ia) + (1.4.4.22a), (Ia) + (1.5.1.1), (Ia) + (1.5.1.2),
(Ia) + (1.5.1.3), (Ia) + (1.5.1.4), (Ia) + (1.5.1.5), (Ia) + (1.5.1.6),
(Ia) + (1.5.1.7), (Ia) + (1.5.1.8), (Ia) + (1.5.1.9), (Ia) + (1.5.1.10),
(Ia) + (1.5.1.11), (Ia) + (1.5.1.12), (Ia) + (1.5.1.13), (Ia) + (1.5.1.14),
(Ia) + (1.5.1.15), (Ia) + (1.5.1.16), (Ia) + (1.5.1.17), (Ia) + (1.5.1.18),
(Ia) + (1.5.1.19), (Ia) + (1.5.1.20), (Ia) + (1.5.1.21), (Ia) + (1.5.1.22),
(Ia) + (1.5.1.23), (Ia) + (1.5.1.24), (Ia) + (1.5.1.25), (Ia) + (1.5.1.26),
(Ia) + (1.5.1.27), (Ia) + (1.5.1.28), (Ia) + (1.5.1.29), (Ia) + (1.5.1.30),
(Ia) + (1.5.1.31), (Ia) + (1.5.1.32), (Ia) + (1.5.1.33), (Ia) + (1.5.1.34),
(Ia) + (1.5.1.35), (Ia) + (1.5.1.36), (Ia) + (1.5.1.37), (Ia) + (1.5.1.38),
(Ia) + (1.5.1.39), (Ia) + (1.5.1.40), (Ia) + (1.5.1.41), (Ia) + (1.5.1.42),
(Ia) + (1.5.1.43), (Ia) + (1.5.1.44), (Ia) + (1.5.1.45), (Ia) + (1.5.1.46),
(Ia) + (1.5.1.47), (Ia) + (1.5.1.48), (Ia) + (1.5.1.49), (Ia) + (1.5.1.50),
(Ia) + (1.6.1), (Ia) + (1.6.2), (Ia) + (1.6.3), (Ia) + (1.6.4), (Ia) + (1.6.5),
(Ia) + (1.6.6), (Ia) + (1.6.7), (Ia) + (1.6.8), (Ia) + (1.6.9), (Ia) + (1.6.10),
(Ia) + (1.6.11), (Ia) + (1.6.12), (Ia) + (1.6.13), (Ia) + (1.6.14), (Ia) + (1.6.15),
(Ia) + (1.6.16), (Ia) + (1.6.17), (Ia) + (1.6.18), (Ia) + (1.6.19), (Ia) + (1.6.20),
(Ia) + (1.6.21), (Ia) + (1.6.22), (Ia) + (1.7.1), (Ia) + (1.7.2), (Ia) + (1.7.3),
(Ia) + (1.7.4), (Ia) + (1.7.5), (Ia) + (1.7.6), (Ia) + (1.7.7), (Ia) + (1.7.8),
(Ia) + (1.7.9), (Ia) + (1.7.10), (Ia) + (1.7.11), (Ia) + (1.7.12), (Ia) + (1.7.13),
(Ia) + (1.7.14), (Ia) + (1.7.15), (Ia) + (1.7.16), (Ia) + (1.7.17), (Ia) + (2.1.1),
(Ia) + (2.1.1a), (Ia) + (2.1.2), (Ia) + (2.1.2a), (Ia) + (2.2.1), (Ia) + (2.2.2),
(Ia) + (2.2.3), (Ia) + (2.2.4), (Ia) + (2.2.5), (Ia) + (2.2.6), (Ia) + (2.2.7), (Ia) + (2.2.8),
(Ia) + (2.2.9), (Ia) + (2.2.10), (Ia) + (2.2.11), (Ia) + (2.2.12), (Ia) + (2.2.13),
(Ia) + (2.2.14), (Ia) + (2.2.15), (Ia) + (2.2.16), (Ia) + (2.2.17), (Ia) + (2.2.18),
(Ia) + (2.2.19), (Ia) + (2.2.20), (Ia) + (2.2.21), (Ia) + (2.2.22), (Ia) + (2.2.23),
(Ia) + (2.2.24), (Ia) + (2.2.25), (Ia) + (2.2.26), (Ia) + (2.2.27), (Ia) + (2.3.1),
(Ia) + (2.3.2), (Ia) + (2.3.3), (Ia) + (2.4.1) (Ia) + (2.4.2).
(Ib) + (1.1.1.1), (Ib) + (1.1.1.2), (Ib) + (1.1.1.3), (Ib) + (1.1.1.4), (Ib) + (1.1.1.5),
(Ib) + (1.1.1.6), (Ib) + (1.1.1.7), (Ib) + (1.1.1.8), (Ib) + (1.1.1.9), (Ib) + (1.1.1.10),
(Ib) + (1.1.1.11), (Ib) + (1.1.1.12), (Ib) + (1.1.1.13), (Ib) + (1.1.1.14), (Ib) + (1.1.1.15),
(Ib) + (1.1.1.16), (Ib) + (1.1.1.17), (Ib) + (1.1.1.18), (Ib) + (1.1.1.19), (Ib) + (1.1.1.20),
(Ib) + (1.1.1.21), (Ib) + (1.1.1.22), (Ib) + (1.1.1.23), (Ib) + (1.1.1.24), (Ib) + (1.1.1.25),
(Ib) + (1.1.1.26), (Ib) + (1.1.1.27), (Ib) + (1.1.1.28), (Ib) + (1.1.1.29), (Ib) + (1.1.1.30),
(Ib) + (1.1.1.31), (Ib) + (1.1.1.32), (Ib) + (1.1.1.33), (Ib) + (1.1.1.34), (Ib) + (1.1.1.35),
(Ib) + (1.1.1.36), (Ib) + (1.1.1.37), (Ib) + (1.1.1.38), (Ib) + (1.1.1.39), (Ib) + (1.1.1.40),
(Ib) + (1.1.1.41), (Ib) + (1.1.1.42), (Ib) + (1.1.1.43), (Ib) + (1.1.1.44), (Ib) + (1.1.1.45),
(Ib) + (1.1.1.46), (Ib) + (1.1.1.47), (Ib) + (1.1.2.1), (Ib) + (1.1.2.2), (Ib) + (1.1.2.3),
(Ib) + (1.1.2.4), (Ib) + (1.1.2.5), (Ib) + (1.1.2.6), (Ib) + (1.1.2.7), (Ib) + (1.1.2.8),
(Ib) + (1.1.2.9), (Ib) + (1.1.2.10), (Ib) + (1.1.3.1), (Ib) + (1.2.1.1), (Ib) + (1.2.1.2),
(Ib) + (1.2.1.3), (Ib) + (1.2.1.4), (Ib) + (1.2.1.5), (Ib) + (1.2.1.6), (Ib) + (1.2.1.7),
(Ib) + (1.2.1.8), (Ib) + (1.2.1.9), (Ib) + (1.2.1.10), (Ib) + (1.2.1.11), (Ib) + (1.2.1.11a),
(Ib) + (1.2.1.11b), (Ib) + (1.2.1.12), (Ib) + (1.2.1.13), (Ib) + (1.2.1.14),
(Ib) + (1.2.1.14a), (Ib) + (1.2.1.14b), (Ib) + (1.2.1.15), (Ib) + (1.2.1.15a),
(Ib) + (1.2.1.15b), (Ib) + (1.2.1.16), (Ib) + (1.2.1.17), (Ib) + (1.2.1.18),
(Ib) + (1.2.1.19), (Ib) + (1.2.1.20), (Ib) + (1.2.1.21), (Ib) + (1.2.1.22),
(Ib) + (1.2.1.23), (Ib) + (1.2.1.24), (Ib) + (1.2.1.25), (Ib) + (1.2.1.26),
(Ib) + (1.2.1.27), (Ib) + (1.2.1.28), (Ib) + (1.2.1.29), (Ib) + (1.2.1.29a),
(Ib) + (1.2.1.29b), (Ib) + (1.2.1.29c), (Ib) + (1.2.1.30), (Ib) + (1.2.1.31),
(Ib) + (1.2.1.32), (Ib) + (1.2.1.33), (Ib) + (1.2.1.33a), (Ib) + (1.2.1.34),
(Ib) + (1.2.1.35), (Ib) + (1.2.1.36), (Ib) + (1.2.1.37), (Ib) + (1.2.1.37a),
(Ib) + (1.2.1.37b), (Ib) + (1.2.1.38), (Ib) + (1.2.1.39), (Ib) + (1.2.1.40),
(Ib) + (1.2.1.41), (Ib) + (1.2.1.42), (Ib) + (1.2.1.43), (Ib) + (1.2.1.44),
(Ib) + (1.2.1.45), (Ib) + (1.2.1.46), (Ib) + (1.2.1.47), (Ib) + (1.2.1.48),
(Ib) + (1.2.1.49), (Ib) + (1.2.1.50), (Ib) + (1.2.1.51), (Ib) + (1.2.1.52),
(Ib) + (1.2.1.53), (Ib) + (1.2.1.54), (Ib) + (1.2.1.55), (Ib) + (1.2.1.56),
(Ib) + (1.2.1.56a), (Ib) + (1.2.1.56b), (Ib) + (1.2.1.57), (Ib) + (1.2.1.57a),
(Ib) + (1.2.1.57b), (Ib) + (1.2.1.58), (Ib) + (1.2.1.59), (Ib) + (1.2.1.60),
(Ib) + (1.2.1.61), (Ib) + (1.2.1.62), (Ib) + (1.2.1.62a), (Ib) + (1.2.1.62b),
(Ib) + (1.2.1.63), (Ib) + (1.2.1.64), (Ib) + (1.2.1.65), (Ib) + (1.2.1.66),
(Ib) + (1.2.1.67), (Ib) + (1.2.1.68), (Ib) + (1.2.1.68a), (Ib) + (1.2.1.68b),
(Ib) + (1.2.1.69), (Ib) + (1.2.2.1), (Ib) + (1.2.2.1a), (Ib) + (1.2.1.1b),
(Ib) + (1.2.1.1c), (Ib) + (1.2.2.2), (Ib) + (1.2.3), (Ib) + (1.2.3.1),
(Ib) + (1.2.3.2), (Ib) + (1.2.3.1a), (Ib) + (1.2.3.1b), (Ib) + (1.2.3.1c),
(Ib) + (1.3.1.1), (Ib) + (1.3.1.1a), (Ib) + (1.3.1.2), (Ib) + (1.3.1.3),
(Ib) + (1.3.1.4), (Ib) + (1.3.1.5), (Ib) + (1.3.1.6), (Ib) + (1.3.1.7),
(Ib) + (1.3.1.8), (Ib) + (1.3.1.9), (Ib) + (1.3.1.10), (Ib) + (1.3.1.11),
(Ib) + (1.3.1.12), (Ib) + (1.3.1.12a), (Ib) + (1.3.1.12b), (Ib) + (1.3.1.12c),
(Ib) + (1.3.1.12d), (Ib) + (1.3.1.12e), (Ib) + (1.3.1.12f), (Ib) + (1.3.1.12g),
(Ib) + (1.3.1.13), (Ib) + (1.3.1.14), (Ib) + (1.3.1.15), (Ib) + (1.3.1.15a),
(Ib) + (1.3.1.16), (Ib) + (1.3.1.17), (Ib) + (1.3.1.17a), (Ib) + (1.3.1.17b),
(Ib) + (1.3.1.17c), (Ib) + (1.3.1.17d), (Ib) + (1.3.1.17e), (Ib) + (1.3.1.17f),
(Ib) + (1.3.1.17g), (Ib) + (1.3.1.18), (Ib) + (1.3.1.19), (Ib) + (1.3.1.20),
(Ib) + (1.3.1.20a), (Ib) + (1.3.1.20b), (Ib) + (1.3.1.20c), (Ib) + (1.3.1.21),
(Ib) + (1.3.1.22), (Ib) + (1.3.1.23), (Ib) + (1.3.1.24), (Ib) + (1.3.1.25),
(Ib) + (1.3.1.26), (Ib) + (1.3.1.27), (Ib) + (1.3.1.28), (Ib) + (1.3.1.29),
(Ib) + (1.3.1.30), (Ib) + (1.3.1.31), (Ib) + (1.3.1.32), (Ib) + (1.3.2.1),
(Ib) + (1.3.2.2), (Ib) + (1.3.2.3), (Ib) + (1.3.2.4), (Ib) + (1.3.2.5),
(Ib) + (1.3.2.6), (Ib) + (1.3.2.7), (Ib) + (1.3.2.8), (Ib) + (1.3.2.9),
(Ib) + (1.3.2.10), (Ib) + (1.3.2.11), (Ib) + (1.3.2.12), (Ib) + (1.3.2.13),
(Ib) + (1.3.2.14), (Ib) + (1.3.2.15), (Ib) + (1.3.2.16), (Ib) + (1.3.2.17),
(Ib) + (1.3.2.18), (Ib) + (1.3.2.19), (Ib) + (1.4.1.1), (Ib) + (1.4.1.2),
(Ib) + (1.4.1.3), (Ib) + (1.4.1.4), (Ib) + (1.4.1.5), (Ib) + (1.4.2.1),
(Ib) + (1.4.2.2), (Ib) + (1.4.2.3), (Ib) + (1.4.2.4), (Ib) + (1.4.2.5),
(Ib) + (1.4.2.6), (Ib) + (1.4.2.7), (Ib) + (1.4.2.8), (Ib) + (1.4.2.9),
(Ib) + (1.4.2.10), (Ib) + (1.4.2.11), (Ib) + (1.4.2.12), (Ib) + (1.4.2.13),
(Ib) + (1.4.2.14), (Ib) + (1.4.2.15), (Ib) + (1.4.2.16), (Ib) + (1.4.2.17),
(Ib) + (1.4.3.1), (Ib) + (1.4.3.2), (Ib) + (1.4.3.3), (Ib) + (1.4.4.1),
(Ib) + (1.4.4.2), (Ib) + (1.4.4.3), (Ib) + (1.4.4.4), (Ib) + (1.4.4.5),
(Ib) + (1.4.4.6), (Ib) + (1.4.4.7), (Ib) + (1.4.4.8), (Ib) + (1.4.4.9),
(Ib) + (1.4.4.10), (Ib) + (1.4.4.11), (Ib) + (1.4.4.12), (Ib) + (1.4.4.13),
(Ib) + (1.4.4.14), (Ib) + (1.4.4.15), (Ib) + (1.4.4.16), (Ib) + (1.4.4.17),
(Ib) + (1.4.4.18), (Ib) + (1.4.4.19), (Ib) + (1.4.4.20), (Ib) + (1.4.4.21),
(Ib) + (1.4.4.22), (Ib) + (1.4.4.22a), (Ib) + (1.5.1.1), (Ib) + (1.5.1.2),
(Ib) + (1.5.1.3), (Ib) + (1.5.1.4), (Ib) + (1.5.1.5), (Ib) + (1.5.1.6),
(Ib) + (1.5.1.7), (Ib) + (1.5.1.8), (Ib) + (1.5.1.9), (Ib) + (1.5.1.10),
(Ib) + (1.5.1.11), (Ib) + (1.5.1.12), (Ib) + (1.5.1.13), (Ib) + (1.5.1.14),
(Ib) + (1.5.1.15), (Ib) + (1.5.1.16), (Ib) + (1.5.1.17), (Ib) + (1.5.1.18),
(Ib) + (1.5.1.19), (Ib) + (1.5.1.20), (Ib) + (1.5.1.21), (Ib) + (1.5.1.22),
(Ib) + (1.5.1.23), (Ib) + (1.5.1.24), (Ib) + (1.5.1.25), (Ib) + (1.5.1.26),
(Ib) + (1.5.1.27), (Ib) + (1.5.1.28), (Ib) + (1.5.1.29), (Ib) + (1.5.1.30),
(Ib) + (1.5.1.31), (Ib) + (1.5.1.32), (Ib) + (1.5.1.33), (Ib) + (1.5.1.34),
(Ib) + (1.5.1.35), (Ib) + (1.5.1.36), (Ib) + (1.5.1.37), (Ib) + (1.5.1.38),
(Ib) + (1.5.1.39), (Ib) + (1.5.1.40), (Ib) + (1.5.1.41), (Ib) + (1.5.1.42),
(Ib) + (1.5.1.43), (Ib) + (1.5.1.44), (Ib) + (1.5.1.45), (Ib) + (1.5.1.46),
(Ib) + (1.5.1.47), (Ib) + (1.5.1.48), (Ib) + (1.5.1.49), (Ib) + (1.5.1.50),
(Ib) + (1.6.1), (Ib) + (1.6.2), (Ib) + (1.6.3), (Ib) + (1.6.4), (Ib) + (1.6.5),
(Ib) + (1.6.6), (Ib) + (1.6.7), (Ib) + (1.6.8), (Ib) + (1.6.9), (Ib) + (1.6.10),
(Ib) + (1.6.11), (Ib) + (1.6.12), (Ib) + (1.6.13), (Ib) + (1.6.14), (Ib) + (1.6.15),
(Ib) + (1.6.16), (Ib) + (1.6.17), (Ib) + (1.6.18), (Ib) + (1.6.19), (Ib) + (1.6.20),
(Ib) + (1.6.21), (Ib) + (1.6.22), (Ib) + (1.7.1), (Ib) + (1.7.2), (Ib) + (1.7.3),
(Ib) + (1.7.4), (Ib) + (1.7.5), (Ib) + (1.7.6), (Ib) + (1.7.7), (Ib) + (1.7.8),
(Ib) + (1.7.9), (Ib) + (1.7.10), (Ib) + (1.7.11), (Ib) + (1.7.12), (Ib) + (1.7.13),
(Ib) + (1.7.14), (Ib) + (1.7.15), (Ib) + (1.7.16), (Ib) + (1.7.17), (Ib) + (2.1.1),
(Ib) + (2.1.1a), (Ib) + (2.1.2), (Ib) + (2.1.2a), (Ib) + (2.2.1), (Ib) + (2.2.2),
(Ib) + (2.2.3), (Ib) + (2.2.4), (Ib) + (2.2.5), (Ib) + (2.2.6), (Ib) + (2.2.7), (Ib) + (2.2.8),
(Ib) + (2.2.9), (Ib) + (2.2.10), (Ib) + (2.2.11), (Ib) + (2.2.12), (Ib) + (2.2.13),
(Ib) + (2.2.14), (Ib) + (2.2.15), (Ib) + (2.2.16), (Ib) + (2.2.17), (Ib) + (2.2.18),
(Ib) + (2.2.19), (Ib) + (2.2.20), (Ib) + (2.2.21), (Ib) + (2.2.22), (Ib) + (2.2.23),
(Ib) + (2.2.24), (Ib) + (2.2.25), (Ib) + (2.2.26), (Ib) + (2.2.27), (Ib) + (2.3.1),
(Ib) + (2.3.2), (Ib) + (2.3.3), (Ib) + (2.4.1) (Ib) + (2.4.2).
(Ic) + (1.1.1.1), (Ic) + (1.1.1.2), (Ic) + (1.1.1.3), (Ic) + (1.1.1.4), (Ic) + (1.1.1.5),
(Ic) + (1.1.1.6), (Ic) + (1.1.1.7), (Ic) + (1.1.1.8), (Ic) + (1.1.1.9), (Ic) + (1.1.1.10),
(Ic) + (1.1.1.11), (Ic) + (1.1.1.12), (Ic) + (1.1.1.13), (Ic) + (1.1.1.14), (Ic) + (1.1.1.15),
(Ic) + (1.1.1.16), (Ic) + (1.1.1.17), (Ic) + (1.1.1.18), (Ic) + (1.1.1.19), (Ic) + (1.1.1.20),
(Ic) + (1.1.1.21), (Ic) + (1.1.1.22), (Ic) + (1.1.1.23), (Ic) + (1.1.1.24), (Ic) + (1.1.1.25),
(Ic) + (1.1.1.26), (Ic) + (1.1.1.27), (Ic) + (1.1.1.28), (Ic) + (1.1.1.29), (Ic) + (1.1.1.30),
(Ic) + (1.1.1.31), (Ic) + (1.1.1.32), (Ic) + (1.1.1.33), (Ic) + (1.1.1.34), (Ic) + (1.1.1.35),
(Ic) + (1.1.1.36), (Ic) + (1.1.1.37), (Ic) + (1.1.1.38), (Ic) + (1.1.1.39), (Ic) + (1.1.1.40),
(Ic) + (1.1.1.41), (Ic) + (1.1.1.42), (Ic) + (1.1.1.43), (Ic) + (1.1.1.44), (Ic) + (1.1.1.45),
(Ic) + (1.1.1.46), (Ic) + (1.1.1.47), (Ic) + (1.1.2.1), (Ic) + (1.1.2.2), (Ic) + (1.1.2.3),
(Ic) + (1.1.2.4), (Ic) + (1.1.2.5), (Ic) + (1.1.2.6), (Ic) + (1.1.2.7), (Ic) + (1.1.2.8),
(Ic) + (1.1.2.9), (Ic) + (1.1.2.10), (Ic) + (1.1.3.1), (Ic) + (1.2.1.1), (Ic) + (1.2.1.2),
(Ic) + (1.2.1.3), (Ic) + (1.2.1.4), (Ic) + (1.2.1.5), (Ic) + (1.2.1.6), (Ic) + (1.2.1.7),
(Ic) + (1.2.1.8), (Ic) + (1.2.1.9), (Ic) + (1.2.1.10), (Ic) + (1.2.1.11), (Ic) + (1.2.1.11a),
(Ic) + (1.2.1.11b), (Ic) + (1.2.1.12), (Ic) + (1.2.1.13), (Ic) + (1.2.1.14),
(Ic) + (1.2.1.14a), (Ic) + (1.2.1.14b), (Ic) + (1.2.1.15), (Ic) + (1.2.1.15a),
(Ic) + (1.2.1.15b), (Ic) + (1.2.1.16), (Ic) + (1.2.1.17), (Ic) + (1.2.1.18),
(Ic) + (1.2.1.19), (Ic) + (1.2.1.20), (Ic) + (1.2.1.21), (Ic) + (1.2.1.22),
(Ic) + (1.2.1.23), (Ic) + (1.2.1.24), (Ic) + (1.2.1.25), (Ic) + (1.2.1.26),
(Ic) + (1.2.1.27), (Ic) + (1.2.1.28), (Ic) + (1.2.1.29), (Ic) + (1.2.1.29a),
(Ic) + (1.2.1.29b), (Ic) + (1.2.1.29c), (Ic) + (1.2.1.30), (Ic) + (1.2.1.31),
(Ic) + (1.2.1.32), (Ic) + (1.2.1.33), (Ic) + (1.2.1.33a), (Ic) + (1.2.1.34),
(Ic) + (1.2.1.35), (Ic) + (1.2.1.36), (Ic) + (1.2.1.37), (Ic) + (1.2.1.37a),
(Ic) + (1.2.1.37b), (Ic) + (1.2.1.38), (Ic) + (1.2.1.39), (Ic) + (1.2.1.40),
(Ic) + (1.2.1.41), (Ic) + (1.2.1.42), (Ic) + (1.2.1.43), (Ic) + (1.2.1.44),
(Ic) + (1.2.1.45), (Ic) + (1.2.1.46), (Ic) + (1.2.1.47), (Ic) + (1.2.1.48),
(Ic) + (1.2.1.49), (Ic) + (1.2.1.50), (Ic) + (1.2.1.51), (Ic) + (1.2.1.52),
(Ic) + (1.2.1.53), (Ic) + (1.2.1.54), (Ic) + (1.2.1.55), (Ic) + (1.2.1.56),
(Ic) + (1.2.1.56a), (Ic) + (1.2.1.56b), (Ic) + (1.2.1.57), (Ic) + (1.2.1.57a),
(Ic) + (1.2.1.57b), (Ic) + (1.2.1.58), (Ic) + (1.2.1.59), (Ic) + (1.2.1.60),
(Ic) + (1.2.1.61), (Ic) + (1.2.1.62), (Ic) + (1.2.1.62a), (Ic) + (1.2.1.62b),
(Ic) + (1.2.1.63), (Ic) + (1.2.1.64), (Ic) + (1.2.1.65), (Ic) + (1.2.1.66),
(Ic) + (1.2.1.67), (Ic) + (1.2.1.68), (Ic) + (1.2.1.68a), (Ic) + (1.2.1.68b),
(Ic) + (1.2.1.69), (Ic) + (1.2.2.1), (Ic) + (1.2.2.1a), (Ic) + (1.2.1.1b),
(Ic) + (1.2.1.1c), (Ic) + (1.2.2.2), (Ic) + (1.2.3), (Ic) + (1.2.3.1),
(Ic) + (1.2.3.2), (Ic) + (1.2.3.1a), (Ic) + (1.2.3.1b), (Ic) + (1.2.3.1c),
(Ic) + (1.3.1.1), (Ic) + (1.3.1.1a), (Ic) + (1.3.1.2), (Ic) + (1.3.1.3),
(Ic) + (1.3.1.4), (Ic) + (1.3.1.5), (Ic) + (1.3.1.6), (Ic) + (1.3.1.7),
(Ic) + (1.3.1.8), (Ic) + (1.3.1.9), (Ic) + (1.3.1.10), (Ic) + (1.3.1.11),
(Ic) + (1.3.1.12), (Ic) + (1.3.1.12a), (Ic) + (1.3.1.12b), (Ic) + (1.3.1.12c),
(Ic) + (1.3.1.12d), (Ic) + (1.3.1.12e), (Ic) + (1.3.1.12f), (Ic) + (1.3.1.12g),
(Ic) + (1.3.1.13), (Ic) + (1.3.1.14), (Ic) + (1.3.1.15), (Ic) + (1.3.1.15a),
(Ic) + (1.3.1.16), (Ic) + (1.3.1.17), (Ic) + (1.3.1.17a), (Ic) + (1.3.1.17b),
(Ic) + (1.3.1.17c), (Ic) + (1.3.1.17d), (Ic) + (1.3.1.17e), (Ic) + (1.3.1.17f),
(Ic) + (1.3.1.17g), (Ic) + (1.3.1.18), (Ic) + (1.3.1.19), (Ic) + (1.3.1.20),
(Ic) + (1.3.1.20a), (Ic) + (1.3.1.20b), (Ic) + (1.3.1.20c), (Ic) + (1.3.1.21),
(Ic) + (1.3.1.22), (Ic) + (1.3.1.23), (Ic) + (1.3.1.24), (Ic) + (1.3.1.25),
(Ic) + (1.3.1.26), (Ic) + (1.3.1.27), (Ic) + (1.3.1.28), (Ic) + (1.3.1.29),
(Ic) + (1.3.1.30), (Ic) + (1.3.1.31), (Ic) + (1.3.1.32), (Ic) + (1.3.2.1),
(Ic) + (1.3.2.2), (Ic) + (1.3.2.3), (Ic) + (1.3.2.4), (Ic) + (1.3.2.5),
(Ic) + (1.3.2.6), (Ic) + (1.3.2.7), (Ic) + (1.3.2.8), (Ic) + (1.3.2.9),
(Ic) + (1.3.2.10), (Ic) + (1.3.2.11), (Ic) + (1.3.2.12), (Ic) + (1.3.2.13),
(Ic) + (1.3.2.14), (Ic) + (1.3.2.15), (Ic) + (1.3.2.16), (Ic) + (1.3.2.17),
(Ic) + (1.3.2.18), (Ic) + (1.3.2.19), (Ic) + (1.4.1.1), (Ic) + (1.4.1.2),
(Ic) + (1.4.1.3), (Ic) + (1.4.1.4), (Ic) + (1.4.1.5), (Ic) + (1.4.2.1),
(Ic) + (1.4.2.2), (Ic) + (1.4.2.3), (Ic) + (1.4.2.4), (Ic) + (1.4.2.5),
(Ic) + (1.4.2.6), (Ic) + (1.4.2.7), (Ic) + (1.4.2.8), (Ic) + (1.4.2.9),
(Ic) + (1.4.2.10), (Ic) + (1.4.2.11), (Ic) + (1.4.2.12), (Ic) + (1.4.2.13),
(Ic) + (1.4.2.14), (Ic) + (1.4.2.15), (Ic) + (1.4.2.16), (Ic) + (1.4.2.17),
(Ic) + (1.4.3.1), (Ic) + (1.4.3.2), (Ic) + (1.4.3.3), (Ic) + (1.4.4.1),
(Ic) + (1.4.4.2), (Ic) + (1.4.4.3), (Ic) + (1.4.4.4), (Ic) + (1.4.4.5),
(Ic) + (1.4.4.6), (Ic) + (1.4.4.7), (Ic) + (1.4.4.8), (Ic) + (1.4.4.9),
(Ic) + (1.4.4.10), (Ic) + (1.4.4.11), (Ic) + (1.4.4.12), (Ic) + (1.4.4.13),
(Ic) + (1.4.4.14), (Ic) + (1.4.4.15), (Ic) + (1.4.4.16), (Ic) + (1.4.4.17),
(Ic) + (1.4.4.18), (Ic) + (1.4.4.19), (Ic) + (1.4.4.20), (Ic) + (1.4.4.21),
(Ic) + (1.4.4.22), (Ic) + (1.4.4.22a), (Ic) + (1.5.1.1), (Ic) + (1.5.1.2),
(Ic) + (1.5.1.3), (Ic) + (1.5.1.4), (Ic) + (1.5.1.5), (Ic) + (1.5.1.6),
(Ic) + (1.5.1.7), (Ic) + (1.5.1.8), (Ic) + (1.5.1.9), (Ic) + (1.5.1.10),
(Ic) + (1.5.1.11), (Ic) + (1.5.1.12), (Ic) + (1.5.1.13), (Ic) + (1.5.1.14),
(Ic) + (1.5.1.15), (Ic) + (1.5.1.16), (Ic) + (1.5.1.17), (Ic) + (1.5.1.18),
(Ic) + (1.5.1.19), (Ic) + (1.5.1.20), (Ic) + (1.5.1.21), (Ic) + (1.5.1.22),
(Ic) + (1.5.1.23), (Ic) + (1.5.1.24), (Ic) + (1.5.1.25), (Ic) + (1.5.1.26),
(Ic) + (1.5.1.27), (Ic) + (1.5.1.28), (Ic) + (1.5.1.29), (Ic) + (1.5.1.30),
(Ic) + (1.5.1.31), (Ic) + (1.5.1.32), (Ic) + (1.5.1.33), (Ic) + (1.5.1.34),
(Ic) + (1.5.1.35), (Ic) + (1.5.1.36), (Ic) + (1.5.1.37), (Ic) + (1.5.1.38),
(Ic) + (1.5.1.39), (Ic) + (1.5.1.40), (Ic) + (1.5.1.41), (Ic) + (1.5.1.42),
(Ic) + (1.5.1.43), (Ic) + (1.5.1.44), (Ic) + (1.5.1.45), (Ic) + (1.5.1.46),
(Ic) + (1.5.1.47), (Ic) + (1.5.1.48), (Ic) + (1.5.1.49), (Ic) + (1.5.1.50),
(Ic) + (1.6.1), (Ic) + (1.6.2), (Ic) + (1.6.3), (Ic) + (1.6.4), (Ic) + (1.6.5),
(Ic) + (1.6.6), (Ic) + (1.6.7), (Ic) + (1.6.8), (Ic) + (1.6.9), (Ic) + (1.6.10),
(Ic) + (1.6.11), (Ic) + (1.6.12), (Ic) + (1.6.13), (Ic) + (1.6.14), (Ic) + (1.6.15),
(Ic) + (1.6.16), (Ic) + (1.6.17), (Ic) + (1.6.18), (Ic) + (1.6.19), (Ic) + (1.6.20),
(Ic) + (1.6.21), (Ic) + (1.6.22), (Ic) + (1.7.1), (Ic) + (1.7.2), (Ic) + (1.7.3),
(Ic) + (1.7.4), (Ic) + (1.7.5), (Ic) + (1.7.6), (Ic) + (1.7.7), (Ic) + (1.7.8),
(Ic) + (1.7.9), (Ic) + (1.7.10), (Ic) + (1.7.11), (Ic) + (1.7.12), (Ic) + (1.7.13),
(Ic) + (1.7.14), (Ic) + (1.7.15), (Ic) + (1.7.16), (Ic) + (1.7.17), (Ic) + (2.1.1),
(Ic) + (2.1.1a), (Ic) + (2.1.2), (Ic) + (2.1.2a), (Ic) + (2.2.1), (Ic) + (2.2.2),
(Ic) + (2.2.3), (Ic) + (2.2.4), (Ic) + (2.2.5), (Ic) + (2.2.6), (Ic) + (2.2.7), (Ic) + (2.2.8),
(Ic) + (2.2.9), (Ic) + (2.2.10), (Ic) + (2.2.11), (Ic) + (2.2.12), (Ic) + (2.2.13),
(Ic) + (2.2.14), (Ic) + (2.2.15), (Ic) + (2.2.16), (Ic) + (2.2.17), (Ic) + (2.2.18),
(Ic) + (2.2.19), (Ic) + (2.2.20), (Ic) + (2.2.21), (Ic) + (2.2.22), (Ic) + (2.2.23),
(Ic) + (2.2.24), (Ic) + (2.2.25), (Ic) + (2.2.26), (Ic) + (2.2.27), (Ic) + (2.3.1),
(Ic) + (2.3.2), (Ic) + (2.3.3), (Ic) + (2.4.1), (Ic) + (2.4.2).

In Table 4:
(Ia)=compound of the formula (Ia) mentioned above, i.e. 2-hydroxy-6-trifluoromethylpyridine-3-carboxamide (or in the tautomeric oxo form: 2-oxo-6-trifluoromethyl-1,2-dihydropyridine-3-carboxamide),
(Ib)=compound of the formula (Ib) mentioned above, i.e. 2-hydroxy-6-difluorochloromethylpyridine-3-carboxamide or in the tautomeric oxo form: 2-oxo-6-difluorochloromethyl-1,2-dihydropyridine-3-carboxamide),
(Ic)=compound of the formula (Ic) mentioned above, i.e. 2-hydroxy-6-difluoromethylpyridine-3-carboxamide (or in the tautomeric oxo form: 2-oxo-6-difluoromethyl-1,2-dihydropyridine-3-carboxamide),
(No.)=compound having the number from Table 3

In addition to the safener/herbicide combinations mentioned (see Table 4), preference is also given to those in which one of the two-component combinations mentioned is extended with a further herbicidally or pesticidally active compound or else a further safener to give a multi-component combination (a combination of three, four or five active compounds). Here, preferred further active compounds are the herbicides or safeners from Table 1 mentioned and the herbicides from Table 2. Here, preference is given to further individual compounds from Table 3 mentioned.

When used as active compound formulations or coformulations, they generally comprise, if appropriate, the respective customary tackifiers, wetting agents, dispersing agents, emulsifiers, penetrants, preservatives, antifreeze agents and solvents, fillers, carriers and colorants, antifoams, evaporation inhibitors and pH- and viscosity-modifying agents.

The compounds of the formula I and their combinations with one or more of the abovementioned pesticides can be formulated in various ways, depending on the prevailing physicochemical and biological parameters. Examples of suitable formulation types are:
emulsifiable concentrates which are prepared by dissolving the active compounds in an organic solvent, for example butanol, cyclohexanone, dimethylformamide, xylene or else relatively high-boiling hydrocarbons or mixtures of the organic solvents with addition of one or more ionic and/or nonionic surfactants (emulsifiers). Suitable emulsifiers are, for example, calcium alkylarylsulfonates, fatty acid polyglycol esters, alkylaryl polyglycol ethers, fatty alcohol polyglycol ethers, propylene oxide/ethylene oxide condensates, alkyl polyethers, sorbitan esters and polyoxyethylenesorbitan fatty acid esters;
dusts, which are obtained by grinding the active compounds with finely dispersed solid inorganic or organic substances, for example talc, natural clays, such as kaolin, bentonite and pyrophyllite, diatomaceous earth or meals;
water- or oil-based suspension concentrates, which can be prepared, for example, by wet grinding using bead mills;
water-soluble powders;
water-soluble concentrates;
granules, such as water-soluble granules, water-dispersible granules and granules for application by broadcasting and soil application;
wettable powders which, in addition to active compound, also contain diluents or inert substances and surfactants;
capsule suspensions and microcapsules;
ultra-low-volume formulations.

The abovementioned formulation types are known to the person skilled in the art and described, for example, in: K. Martens, “Spray Drying Handbook”, 3rd Ed., G. Goodwin Ltd., London, 1979; W. van Valkenburg, “Pesticide Formulations”, Marcel Dekker, N.Y. 1973; Winnacker-Kuchler, “Chemische Technologie” [Chemical Technology], volume 7, C. Hanser Verlag Munich, 4th edition 1986; “Perry's Chemical Engineer's Handbook”, 5th Ed., McGraw-Hill, N.Y. 1973, pages 8-57.

The formulation auxiliaries required, such as inert materials, surfactants, solvents and other additives are also known and are described, for example, in: McCutcheon's “Detergents and Emulsifiers Annual”, MC PubI. Corp., Ridgewood N.J.; C. Marsden, “Solvents Guide”, 2nd Ed., Interscience, N.Y. 1963; H. von Olphen, “Introduction to Clay Colloid Chemistry”, 2nd Ed., J. Wiley & Sons, N.Y.; Schbnfeldt, “Grenzflachenaktive Athylenoxidaddukte” [Surface-active ethylene oxide adducts], Wiss. Verlagsgesellschaft, Stuttgart 1976; Sisley and Wood, “Encyclopedia of Surface Active Agents”, Chem. Publ. Co. Inc., N.Y. 1964; Watkins, “Handbook of Insecticide Dust Diluents and Carriers”, 2nd Ed., Darland Books, Caldwell N.J.; Winnacker-Kuchler, “Chemische Technologie” [Chemical Technology], volume 7, C. Hanser Verlag Munich, 4th edition 1986.

In addition to the abovementioned formulation auxiliaries, the useful-plant-protecting compositions may comprise, if appropriate, customary tackifiers, wetting agents, dispersants, penetrants, emulsifiers, preservatives, antifreeze agents, fillers, carriers, colorants, anti-foams, evaporation inhibitors and pH or viscosity regulators.

Depending on the formulation type, the useful-plant-protecting compositions generally comprise 0.1 to 99% by weight, in particular 0.2 to 95% by weight, of one or more safeners of the formula I or a combination of safener and pesticide. Furthermore, they comprise 1 to 99.9, in particular 4 to 99.5,% by weight of one or more solid or liquid additives and 0 to 25, in particular 0.1 to 25,% by weight of a surfactant. In emulsifiable concentrates, the concentration of active compound, i.e. the concentration of safener and/or pesticide, is generally 1 to 90, in particular 5 to 80,% by weight. Dusts usually comprise 1 to 30, preferably 5 to 20,% by weight of active compound. In wettable powders, the concentration of active compound is generally 10 to 90% by weight. In water-dispersible granules, the content of active compound is, for example, between 1 and 95% by weight, preferably between 10 and 80% by weight.

For use, the formulations, which are present in commercially available form, are, if appropriate, diluted in a customary manner, for example in the case of wettable powders, emulsifiable concentrates, dispersions and water-dispersible granules, with water. Preparations in the form of dusts, granules and sprayable solutions are usually not diluted with any further inert substances prior to use. The required application rate of the safeners varies with the external conditions such as, inter alia, temperature, humidity and the type of herbicide used.

In the examples below (formulation examples, preparation examples, biological examples) which illustrate the invention but do not limit it, the amounts are based on weight, unless defined otherwise.

### EXAMPLES

### 1 Formulation Examples

### 1.1 Dusting Agent

A dusting agent is obtained by mixing 10 parts by weight of a compound of the formula (I) or of an active compound mixture of a pesticide (eg. herbicide) and a safener of the formula (I) and 90 parts by weight of talc as inert material and comminuting in a hammer mill.

### 1.2 Water-Dispersible Powder

A wettable powder which is readily dispersible in water is obtained by mixing 25 parts by weight of a compound of the formula (I) or of an active compound mixture of a pesticide (eg. herbicide) and a safener of the formula (I), 64 parts by weight of kaolin-containing quartz as inert material, 10 parts by weight of potassium ligninsulfonate and 1 part by weight of sodium oleoylmethyltaurinate as wetting and dispersing agent, and grinding in a pin mill.

### 1.3 Water-Dispersible Concentrate

A dispersion concentrate which is readily dispersible in water is obtained by mixing 20 parts by weight of a compound of the formula (I) or of an active compound mixture of a pesticide (eg. herbicide) and a safener of the formula (I) with 6 parts by weight of alkylphenol polyglycol ether (®Triton X 207), 3 parts by weight of isotridecanol polyglycol ether and 71 parts by weight of paraffinic mineral oil and grinding in a ball mill to a fineness of below 5 microns.

### 1.4 Emulsifiable Concentrate

An emulsifiable concentrate is obtained from 15 parts by weight of a compound of the formula (I) or of an active compound mixture of a pesticide (eg. herbicide and a safener of the formula (I), 75 parts by weight of cyclohexanone as solvent and 10 parts by weight of ethoxylated nonylphenol as emulsifier.

### 1.5 Water-Dispersible Granules

Water-dispersible granules are obtained by mixing
75 parts by weight of a safener of the formula (I) or of a mixture of a pesticide and a safener of the formula (I),
10 ″ of calcium ligninsulfonate,
5 ″ of sodium lauryl sulfate,
3 ″ of polyvinyl alcohol and
7 ″ of kaolin,
   grinding in a pin mill and granulating the powder in a fluidized bed by spraying on water as granulation liquid.

Water-dispersible granules are also obtained by homogenizing
25 parts by weight of a safener of the formula (I) or of a mixture of a pesticide and a safener of the formula (I),
5 ″ of sodium 2,2′-dinaphthylmethane-6,6′-disulfonate,
2 ″ of sodium oleoylmethyltaurinate,
17 ″ of calcium carbonate,
50 ″ of water and
1 part by weight of polyvinyl alcohol
   in a colloid mill, comminuting, then grinding in a bead mill and atomizing and drying the resulting suspension in a spray tower using a single-fluid nozzle.

### 2. Preparation Examples

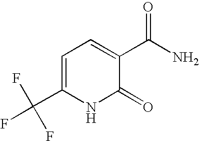

### Example 1

### 2-Oxo-6-trifluoromethyl-1,2-dihydropyridine-3-carboxamide

### 1.1) 4-Butoxy-1,1,1-trifluorobut-3-en-2-one

With stirring at 5° C., 79.9 g (0.38 mol) of trifluoroacetic anhydride—dissolved in 100 ml of trichloromethane—were added to a mixture of 29.9 g (0.38 mol) of pyridine and 50.0 g (0.38 mol) of butyl vinyl ether in 200 ml of trichloromethane. After the addition, stirring was continued at room temperature for another 15 h. 300 ml of water were then added to the mixture, and the organic phase was separated off, dried and concentrated. This gave 59 g (79% of theory) of a yellowish oil.

1H-NMR: [CDCl₃] 0.96 (t, 3H); 1.41 (m, 2H); 1.73 (m, 2H); 4.04 (t, 2H); 5.85 (d, 1H); 7.90 (d, 1H)

### 1.2) 2-Oxo-6-trifluoromethyl-1,2-dihydropyridine-3-carboxamide

2.81 g (0.122 mol) of sodium were dissolved in 200 ml of ethanol, 20.0 g (0.102 mol) of 4-butoxy-1,1,1-trifluorobut-3-en-2-one and 10.41 g (0.102 mol) of malonamide were then added, and the mixture was heated under reflux for 7 h. The mixture was then concentrated slightly (about 50 ml), and 1N hydrochloric acid was added. The resulting precipitate was filtered off with suction and dried. This gave 12.9 g (61% of theory) of a yellow powder.

1H-NMR: [DMSO] 7.40 (br, 1H); 8.10 (br, 1H); 8.45 (d, 2H); 13.7 (br, 1H).

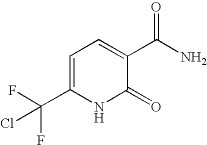

### Example 2

### 6-Chloro(difluoro)methyl-2-oxo-1,2-dihydropyridine-3-carboxamide

### 2.1) 4-Butoxy-1-chloro-1,1-difluorobut-3-en-2-one

With stirring at 5° C., 5.0 g (20.2 mmol) of chlorodifluoroacetic anhydride—dissolved in 10 ml of trichloromethane—were added to a mixture of 1.60 g (20.2 mmol) of pyridine and 2.1 g (20.2 mmol) of butyl vinyl ether in 30 ml of trichloromethane. After the addition, stirring was continued at room temperature for another 15 h. 100 ml of water were then added to the mixture, and the organic phase was separated off, dried and concentrated. This gave 3.4 g (80% of theory) of a yellowish oil.

1H-NMR: [DMSO] 0.90 (t, 3H); 1.35 (m, 2H); 1.65 (m, 2H); 4.20 (t, 2H); 6.04 (d, 1H); 8.10 (d, 1H).

### 2.2) 6-Chloro(difluoro)methyl-2-oxo-1,2-dihydropyridine-3-carboxamide

1.29 g (55.9 mmol) of sodium were dissolved in 150 ml of ethanol, 9.90 g (46.6 mol) of 4-butoxy-1-chloro-1,1-difluorobut-3-en-2-one and 4.90 g (46.6 mmol) of malonamide were then added, and the mixture was heated under reflux for 5 h. The mixture was then concentrated slightly (about 50 ml), and 1N hydrochloric acid was added. The resulting precipitate was filtered off with suction and dried. This gave 4.2 g (41% of theory) of a yellow powder.

1H-NMR: [DMSO] 7.35 (d, 1H); 8.10 (br, 1H); 8.40 (d, 1H); 8.41 (br, 1H); 13.6 (br, 1H).

Other compounds of the formula (I) can be prepared in an analogous manner.

### 3. Biological Examples

### 3.1 Scoring of the Damage

The damage to the plants is scored visually using a scale of 0-100%, in comparison to control plants:

0%=no noticeable effect compared to the untreated plant
100%=the treated plants dies.

### 3.2 Post-Emergence Herbicide Action and Safener Action

Seeds or rhizome pieces of monocotyledonous and dicotyledonous harmful plants and crop plants are placed in sandy loam soil in plastic pots, covered with soil and cultivated in the greenhouse under good growth conditions. Alternatively, harmful plants encountered in paddy rice cultivation are cultivated in pots in which the surface of the soil is covered by up to 2 cm of water. Ten to twenty days after sowing, the test plants are treated at the one to three-leaf stage. The herbicide/safener active compound combinations according to the invention, formulated as water-soluble powders or suspensions, and in parallel tests the individual active compounds formulated in a corresponding manner, are sprayed at various dosages at a water application rate of 300 l/ha (converted) onto the green parts of the plants, and, after the test plants were left to stand in the greenhouse for about 2 to 3 weeks under optimum growth conditions, the effect of the preparations is scored visually in comparison to untreated controls. In the case of rice or harmful plants encountered in the cultivation of rice, the active compounds are also added directly to the irrigation water (application analogously to the so-called granule application) or sprayed onto the plants and into the irrigation water.

The tests show that the safeners according to the invention, for example the compounds of the formulae (Ia), (Ib) and (Ic), in combination with herbicides substantially reduce damage caused by the respective herbicide to crop plants such as corn, rice, wheat or barley or other cereals compared to the application of the individual herbicides without safener, i.e. by 20% up to 100% less damage to the crop plant is observed. At the same time, the action of the herbicide against economically important harmful plants is not, or not substantially, adversely affected, so that good herbicidal post-emergence action against a broad spectrum of weed grases and broad-leaved weeds can be achieved. Some test results are compiled in Table 5.

TABLE 5
Post-emergence herbicide action and safener action

| | Dose of | Dose of | | |
|---|---|---|---|---|
| Herbicide | herbicide | safener (Ia) | | Reduction of the |
| No. | [g of AS/ha] | [g of AS/ha] | Crop plant | harmful effect |
| (1.3.1.20c) | 400 | 100 | HORVU | category A |
| (1.3.1.20c) | 100 | 20 | TRZAS | category A |
| (1.2.1.14) | 40 | 80 | TRZAS | category A |
| (1.1.1.10) | 20 | 100 | HORVU | category A |
| (1.1.1.10) | 20 | 80 | TRZAS | category A |
| (1.2.1.58) | 15 | 100 | HORVU | category A |
| (1.2.1.58) | 15 | 100 | TRZAS | category A |
| (1.1.2.10) | 200 | 100 | TRZAS | category A |
| (2.2.12) | 100 | 50 | TRZAS | category B |
| (2.2.12) | 50 | 50 | ZEAMX | category A |
| (1.2.1.48) | 100 | 50 | ZEAMX | category A |
| (1.2.1.11b) | 100 | 50 | ZEAMX | category B |
| (1.1.1.4) | 400 | 75 | ORYSA | category A |
| (1.1.1.4)*⁾ | 600 | 75 | ORYSA | category A |
| (1.3.1.20c) | 100 | 300 | ORYSA | category A |
| (1.2.1.58) | 10 | 300 | ORYSA | category A |
| (1.2.1.15) | 15 | 100 | ORYSA | category B |
| (1.2.1.14) + | 4 + 0.8 | 150 | ORYSA | category A |
| (1.2.1.11b) | | | | |
| (1.2.1.62b) | 200 | 75 | ORYSA | category A |

Abbreviations in Table 5:
Herbicide No. = Herbicide according to the number from Table 4 or Table 3
safener (Ia) = Safener according to formula (Ia), i.e. 2-oxo-6-trifluoromethyl-1,2-dihydropyridine-3-carboxamide
category A = 50-100% reduction of the harmful action
category B = 20-49% reduction of the harmful action
AS = active substance (based on 100% active compound)
*⁾= applied to the water around the test plants (paddy rice conditions)
HORVU = Hordeum vulgare (barley)
TRZAS = Triticum aestivum (spring wheat)
ZEAMX = Zea mays (corn)
ORYSA = Oryza sativa (rice)

### 3.3 Pre-Emergence Herbicide Action AND Safener Action

Seeds or rhizome pieces of monocotyledonous and dicotyledonous weed plants and crop plants were placed in sandy loam soil in plastic pots and covered with soil. The herbicide/safener active compound combinations according to the invention, formulated as water-soluble powders or suspensions, and in parallel tests the individual active compounds formulated in a corresponding manner, were then, at various dosages at a water application rate of 300 to 800 l/ha (converted), applied to the surface of the covering soil.

After the treatment, the pots were placed in the greenhouse and kept under good growth conditions for the weeds and the crop plants. Visual scoring of the plant damage or emergence damage was carried out after the test plants had emerged after a test period of 2 to 4 weeks, in comparison to untreated controls.

The tests show that the safeners according to the invention, for example the compounds of the formulae (Ia), (Ib) and (Ic), in combination with herbicides substantially reduce damage caused by the respective herbicide to crop plants such as corn, rice, wheat or barley or other cereals compared to the application of the individual herbicides without safener, i.e. by 20% up to 100% less damage to the crop plant is observed. At the same time, the action of the respective herbicide against economically important harmful plants is not, or not substantially, adversely affected, so that good herbicidal pre-emergence action against a broad spectrum of weed grases and broad-leaved weeds can be achieved. Some test results are compiled in Table 6.

TABLE 6
Pre-emergence herbicide action and safener action

| | Dose of | Dose of | | |
|---|---|---|---|---|
| Herbicide | herbicide | safener (Ia) | | Reduction of the |
| No. | [g of AS/ha] | [g of AS/ha] | Crop plant | harmful effect |
| (1.1.1.22) | 300 | 300 | ZEAMX | category A |
| (1.4.4.17) | 125 | 150 | ZEAMX | category A |
| (2.2.16) | 400 | 75 | ORYSA | category B |

Abbreviations in Table 6:
Herbicide No. = Herbicide according to the number from Table 4 or Table 3
safener (Ia) = Safener according to formula (Ia), i.e. 2-oxo-6-trifluoromethyl-1,2-dihydropyridine-3-carboxamide
AS = active substance (based on 100% active compound)
category A = 50-100% reduction of the harmful action
category B = 20-49% reduction of the harmful action
ZEAMX = Zea mays (corn)
ORYSA = Oryza sativa (rice)

### 3.4 Seed Treatment

Seeds of crop plants were mixed in bottles with the safeners according to the invention, formulated as suspension or emulsion concentrates, and water, and the mixture was shaken well so that the seeds were coated evenly with the formulation of the safener in question. The seeds or the emerged plants were then tested with herbicides in the pre- or post-emergence method according to the tests of examples 3.3 and 3.2, respectively.

In the treatment of seed, too, the safeners showed good activity. The herbicidal action of the herbicidally active compounds used was not adversely affected.

Some test results are compiled in Table 7.

TABLE 7
Herbicide action and safener action in the treatment of seed with
safeners

| | | Dose of | | |
|---|---|---|---|---|
| | Dose of | safener (Ia) | | |
| Herbicide | herbicide | [g of AS/kg | | Reduction of the |
| No. | [g of AS/ha] | seed] | Crop plant | harmful effect |
| (1.2.1.14) | 30 | 0.5 | HORVU | category A |
| (1.2.1.14) | 30 | 1.0 | TRZAS | category A |
| (1.2.1.58) | 15 | 1.0 | HORVU | category A |
| (1.2.1.58) | 15 | 1.0 | TRZAS | category A |
| (1.2.1.58) | 5 | 1.0 | ZEAMX | category A |
| (1.1.1.22) | 200 | 0.5 | ZEAMX | category A |

Abbreviations in Table 7:
Herbicide No. = Herbicide according to the number from Table 4 or Table 3
safener (Ia) = Safener according to formula (Ia), i.e. 2-oxo-6-trifluoromethyl-1,2-dihydropyridine-3-carboxamide
AS = active substance (based on 100% active compound)
category A = 50-100% reduction of the harmful action
HORVU = Hordeum vulgare (barley)
TRZAS = Triticum aestivum (spring wheat)
ZEAMX = Zea mays (corn)

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method for protecting useful plants against phytotoxic side effects of pesticides, which comprises applying an effective amount of one or more compounds of the general formula (I) or salts thereof, 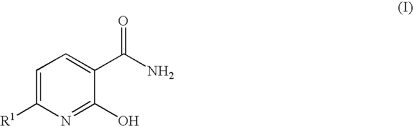
in which
R¹ is a (C₁-C₄)-haloalkyl radical,
before, after or simultaneously with the pesticide or pesticides to the plants, part of the plants, the plant seeds or seed of the plants.

2. The method as claimed in claim 1, wherein
R¹ is a radical of the formula CF₃, CF₂C₁ or CF₂H.

3. The method as claimed in claim 1, wherein
R¹ is a radical of the formula CF₃.

4. The method as claimed in claim 1, wherein
R¹ is a radical of the formula CF₂Cl.

5. The method as claimed in claim 1, wherein
R¹ is a radical of the formula CF₂H.

6. The method as claimed in claim 1, wherein the application is by the post-emergence method.

7. The method as claimed in claim 1, wherein the application of the compound of the formula (I) or a salt thereof is by treating the plant seeds or the seed of the plants.

8. The method as claimed in claim 1, wherein the application is by the pre-emergence method.

9. A method for the selective control of harmful plants in crops of useful plants, which comprises applying an effective useful-plant-protecting amount of one or more compounds of the formula (I) or salts thereof as defined in claim 1 before, after or simultaneously with an effective amount of one or more herbicides to the plants, parts of plants, plant seeds or the seed of the plants.

10. The method as claimed in claim 9, which comprises treating the seed with one or more compounds of the formula (I) or salts thereof and applying the herbicide after sowing by the pre-emergence method or by the post-emergence method.

11. The method as claimed in claim 9 wherein a crop protection composition comprising one or more compounds of formula (I) or salts thereof and one or more pesticides and, optionally, formulation auxiliaries are applied.

12. A crop protection composition which comprises one or more compounds of the formula (I) or salts thereof as defined in claim 1 and formulation auxiliaries or one or more pesticides and, optionally, formulation auxiliaries.

13. The crop protection composition as claimed in claim 12 which comprises one or more pesticides and, optionally, formulation auxiliaries.
